(19) United States
(12) Patent Application Publication
(10) Pub. No.: US 2025/0131504 A1
(43) Pub. Date: Apr. 24, 2025

(54) POLLING BASED RESOURCE MANAGEMENT AMONG DISTRIBUTED CLIENTS

(71) Applicant: Collective Intelligence Group LLC, New York, NY (US)

(72) Inventor: Peter Brodsky, New York, NY (US)

(73) Assignee: Collective Intelligence Group LLC, New York, NY (US)

(21) Appl. No.: 18/922,218

(22) Filed: Oct. 21, 2024

Related U.S. Application Data
(60) Provisional application No. 63/545,051, filed on Oct. 20, 2023.

(51) Int. Cl. G06Q 40/06

(52) U.S. Cl. CPC G06Q 40/06; G06Q 2230/00

(57) ABSTRACT

Described herein are examples of systems and methods for conducting polls among clients. The clients can submit votes in the poll, such as a vote to increase or decrease an allocation of resources to a particular organization. After a client submits a vote in the poll, the techniques described herein can confirm an amplification amount that the client has applied to the vote is less than an amplification available to the client for the poll. For example, the amplification can be a weighting factor that allows the client to indicate the importance of their vote. If the amplification applied by the client is less than the available amplification for the client, then the vote can be recorded. For example, the vote can be recorded in a data structure of a distributed data store for the poll.

### CROSS REFERENCE TO RELATED APPLICATION

This application claims the benefit under 35 U.S.C. § 119 (e) of U.S. Provisional Patent Application No. 63/545,051, filed Oct. 20, 2023, the entire contents of which are incorporated herein by reference.

### BACKGROUND

Many different forms of governance structures have been tried over time, as people seek to organize themselves and make decisions for a collective. Some approaches include endowing single leaders or small groups with the discretion to make choices for the collective. Others include having members of the collective voice their opinions on matters that may affect members or the collective. In the latter approach, members may submit votes on options that have been made available, and a winning option may be one that receives a number of votes (e.g., the majority).

### SUMMARY

In some aspects, the techniques described herein relate to a method of conducting a poll among a plurality of clients, the method including: in response to a first client of the plurality of clients submitting a vote in the poll, confirming, by at least one processor, whether an amplification that the first client has applied to the vote is less than an amplification available to the first client for the poll; and recording, by the at least one processor, the vote of the first client in a distributed data store for the poll, wherein recording the vote includes recording in a data structure of the distributed data store an identifier for the vote of the first client, an identifier for a preceding vote in the poll, the amplification applied to the vote by the first client, and a vote choice of the first client in the poll.

In some aspects, the techniques described herein relate to a method, further including: decreasing, by the at least one processor, the amplification available to the first client for the poll based on the amplification applied to the vote by the first client.

In some aspects, the techniques described herein relate to a method, further including: modifying, by the at least one processor, based on the amplification applied to the vote by the first client, a respective amplification available to other clients, of the plurality of clients, for future polls.

In some aspects, the techniques described herein relate to a method, further including: identifying, by the at least one processor, that one or more of the plurality of clients submitted one or more tags associated with the poll; identifying, by the at least one processor, that one or more of the plurality of clients submitted one or more interactions with the one or more tags associated with the poll; and generating, by the at least one processor, an order of display of the one or more tags based on the one or more interactions.

In some aspects, the techniques described herein relate to a method, wherein the first client submitting the vote includes: detecting, by the at least one processor, that the first client has submitted a first vote for a first option of the poll and a second vote for a second option of the poll; confirming, by the at least one processor, whether a first amplification the first client has applied to the first vote and a second amplification the first client has applied to the second vote are collectively less than the amplification available to the first client for the poll; and recording, by the at least one processor, the first vote and the second vote of the first client in a the distributed data store for the poll, wherein recording the vote includes recording in the data structure of the distributed data store a first identifier for the first vote and a second identifier for the second vote of the first client, the identifier for the preceding vote in the poll, and the first amplification and the second amplification applied to the first vote and the second vote by the first client.

In some aspects, the techniques described herein relate to a method, wherein the vote of the first client is recorded responsive to confirming, by at least one processor, that a time at which the first client has applied to the vote satisfies a time condition until when the vote can be recorded for the poll.

In some aspects, the techniques described herein relate to a method, further including: detecting, by the at least one processor, a plurality of deadline votes submitted by the plurality of clients on at least one time-condition until the vote for the poll can be recorded; and recording, by the at least one processor, a time condition of the at least one time-condition based on the plurality of deadline votes indicating the time-condition.

In some aspects, the techniques described herein relate to a method, further including: receiving, by the at least one processor, from the first client of the plurality of clients submitting a vote in the poll, a resource selection of resources to assign to at least one other client of the plurality of clients; selecting, by the at least one processor, based on the resource selection, a subset of the resources to transfer to the at least one other client of the plurality of clients; and transferring, by the at least one processor, the subset of the resources to the at least one other client.

In some aspects, the techniques described herein relate to a method, further including: detecting, by the at least one processor, a request submitted by the first client to transfer resources from the first client to at least one new client; and transferring, by the at least one processor, responsive to confirming that the resources in the first request is less than a maximum resource available to the first client, the resources from the first client to the at least one new client.

In some aspects, the techniques described herein relate to a method, further including: detecting, by the at least one processor, a request submitted by the first client to remove shares of resources from the first client to remove the resources from a second client of the plurality of clients; and transferring, by the at least one processor, the shares of the resources from the first client and the second client to the plurality of clients.

In some aspects, the techniques described herein relate to a method of electronically conducting a poll among a plurality of clients, the method including: identifying, by at least one processor, a cryptographically-sealed sequence of votes for the poll, the cryptographically-sealed sequence of votes being stored in a distributed data store for the poll; in accordance with an order of votes indicated by the cryptographically-sealed sequence of votes, obtaining, by the at least one processor, for each vote in the poll, a choice of the vote by a client of the plurality of clients and an amplification applied to the vote by the client submitting the vote; and updating, by the at least one processor, shares of resources assigned to each client of the plurality of clients, based on choices of votes and the amplification applied to each vote in the poll.

In some aspects, the techniques described herein relate to a method, wherein each vote in the poll is associated with the shares of equity, and wherein allocating the shares of allocations includes: distributing, by the at least one processor, the allocations among the plurality of clients; and transferring, by the at least one processor, among the plurality of clients, the shares of the resources based on the amplification applied to the votes in the poll.

In some aspects, the techniques described herein relate to a method, wherein the shares of the allocations among the plurality of clients are distributed based a number of clients of the plurality of clients.

In some aspects, the techniques described herein relate to a method, further including: transferring, by the at least one processor, from a first client of the plurality of clients to which the shares of resources were allocated, a subset of the shares of resources to at least one different client of the plurality of clients.

In some aspects, the techniques described herein relate to a method, further including: detecting, by the at least one processor, from the first client of the plurality of clients, a client selection of the at least one different client of the plurality of clients to which the subset of the shares of resources should be transferred.

In some aspects, the techniques described herein relate to a method, wherein allocating includes: identifying, by the at least one processor, a winning client of the plurality of clients that received the greatest amplification based on the amplification applied to each vote in the poll; and assigning, by the at least one processor, the shares of resources to the winning client. In some aspects, the techniques described herein relate to a method, wherein allocating includes: identifying, by the at least one processor, a subset of clients of the plurality of clients selected in each vote in the poll; identifying, by the at least one processor, for each of the subset of clients, a proportion of the amplification associated with the client; and assigning, by the at least one processor, the shares of resources to each of the subset of clients based on the proportion amplification.

In some aspects, the techniques described herein relate to a method, wherein the cryptographically sealed sequence of votes is a hash chain.

In some aspects, the techniques described herein relate to a method of electronically conducting a poll among a plurality of clients, the method including: identifying, by at least one processor, a cryptographically-sealed sequence of votes for the poll, the cryptographically-sealed sequence of votes being stored in a distributed data store for the poll; in accordance with an order of votes indicated by the cryptographically-sealed sequence of votes, obtaining, by the at least one processor, for each vote in the poll, a choice of the vote by a client of the plurality of clients and an amplification applied to the vote by the client submitting the vote; and determining, by the at least one processor, an outcome of the poll based on choices of votes and the amplification applied to each vote in the poll.

In some aspects, the techniques described herein relate to a method, wherein determining the outcome includes: determining, by the at least one processor, the outcome of the poll by identifying a winning client of the plurality of clients that received the greatest amplification based on the amplification applied to each vote in the poll; and assigning, by the at least one processor, shares of resources to the winning client.

In some aspects, the techniques described herein relate to a method, wherein determining the outcome includes: determining, by the at least one processor, the outcome of the poll by: identifying a subset of clients of the plurality of clients selected in each vote in the poll; identifying for each of the subset of clients, a proportion of the amplification associated with the client; and assigning the amounts of shares to each of the subset of clients based on the proportion of the amplification.

In some aspects, the techniques described herein relate to a method, wherein obtaining the choice of the vote includes: identifying, by the at least one processor, for each vote in the poll, a public key for decrypting the respective choice of the vote by the client of the plurality of clients and the amplification applied to the vote by the client submitting the vote; and obtaining, by the at least one processor, for each vote in the poll, a choice of the vote by a client of the plurality of clients and the amplification applied to the vote by the client submitting the vote.

In some aspects, the techniques described herein relate to a method, further including: identifying, by the at least one processor, in the cryptographically sealed sequence of votes provided by the client, a hash chain including a respective hash for each vote in the poll, wherein the respective hash is associated with a respective choice of the vote by a respective client of the plurality of clients and a respective amplification applied to the vote by the respective client submitting the vote; generating, by the at least one processor, a comparison between the hash chain of the cryptographically sealed sequence of votes of the client and a different hash chain of a different cryptographically sealed sequence of votes provided by a different client; and determining, by the at least one processor, based on the comparison, whether to verify the cryptographically sealed sequence of votes.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a system using for allocating resources, in accordance with some embodiments of the technology described herein;

FIG. 2 is a schematic diagram of a system using for allocating resources, in accordance with some embodiments of the technology described herein;

FIG. 3 is a flowchart of an illustrative method 300 of defining a poll among the clients, in accordance with some embodiments of the technology described herein;

FIG. 4 is a flowchart of an illustrative method 400 of managing polls for the clients, in accordance with some embodiments of the technology described herein;

FIG. 5 is a flowchart of an illustrative method 500 of managing cryptographic voting among the clients, in accordance with some embodiments of the technology described herein;

FIG. 6 is a flowchart of an illustrative method 600 of determining outcomes from cryptographic voting among the clients, in accordance with some embodiments of the technology described herein;

FIG. 7 is a flowchart of an illustrative method 700 of managing auction voting among the clients, in accordance with some embodiments of the technology described herein;

FIG. 8 is a flowchart of an illustrative method 800 of prioritizing issues among the clients, in accordance with some embodiments of the technology described herein;

FIG. 9 is a flowchart of an illustrative method 900 of managing amplification for voting among the clients, in accordance with some embodiments of the technology described herein;

FIG. 10 is a flowchart of an illustrative method 1000 of managing realm resources among the clients, in accordance with some embodiments of the technology described herein;

FIG. 11 is a flowchart of an illustrative method 1100 of managing shares of resources among the clients, in accordance with some embodiments of the technology described herein;

FIG. 12 is a flowchart of an illustrative method 1200 of managing equity transfers among the clients, in accordance with some embodiments of the technology described herein;

FIG. 13 is a flowchart of an illustrative method 1300 of managing taxes on equity among the clients, in accordance with some embodiments of the technology described herein;

FIG. 14 is a flowchart of an illustrative method 1400 of managing new clients, in accordance with some embodiments of the technology described herein;

FIG. 15 is a flowchart of an illustrative method 1500 of negating equity, in accordance with some embodiments of the technology described herein; and

FIG. 16 is a schematic diagram of an illustrative computing device with which some aspects described herein may be implemented.

### DETAILED DESCRIPTION

Described herein are examples of systems and methods for conducting polls among clients. Examples of clients include client devices representing organizations, members, managers, and/or individuals participating in the poll. The clients can submit votes in the poll, such as a vote to increase or decrease an allocation of resources to a particular organization. After a client submits a vote in the poll, the techniques described herein can confirm an amplification amount that the client has applied to the vote is less than an amplification available to the client for the poll. For example, each of the clients can be initialized with an available amplification, which can represent the power that the client can apply to the vote. In another example, the amplification can be a weighting factor that allows the client to indicate the importance of their vote. If the amplification applied by the client is less than the available amplification for the client, then the vote can be recorded. For example, the vote can be recorded in a data structure of a distributed data store for the poll. The data structure can include an identifier for the vote of the client, an identifier for a preceding vote in the poll, the amplification amount applied to the vote by the client, and a vote choice of the client in the poll.

Some implementations described herein can be useful for cryptographically conducting a poll among clients. The techniques described herein can identify a cryptographically-sealed sequence of votes for the poll. The cryptographically-sealed sequence of votes can be stored in a distributed data store for the poll. For example, the distributed data store can be an encrypted blockchain that stores the cryptographically-sealed sequence of votes. The cryptographically-sealed sequence can indicate an order of the votes. For example, each vote can be added to the cryptographically-sealed sequence in the order that they are submitted so that the cryptographically-sealed sequence can represent, at any given time, the submitted votes up to that point. The cryptographically-sealed sequence can be decrypted (e.g., by an authorized client) to identify a choice of the vote and an amplification amount applied to the vote by each of the clients that have submitted votes, to determine an outcome of the poll.

For thousands of years, humans have attempted to identify the best way to manage decisions that affect a group of people. Innumerable techniques have been tried over time and disagreement over a good way to make the decisions continues even to today. Often, a decision technique for a group falls into one of two rough categories, between imbuing a person or small group with decision-making authority or having people vote on options to make the decisions.

The difficulties with having one person or a small group make decisions on behalf of a larger group are well-documented throughout history. For the system to work well, the person or small group must be trusted to make decisions that are in the best interests of the group, but the person/group may not always do so. This may be because the person/group is misinformed about the best interests of the group, holds different opinions on what is best for the group, or is interested in making decisions that are best for themselves or otherwise not what is best for the group. This has repeated over and over throughout human history, but despite this well-known difficulty, groups still often ask a person or small group to make management decisions for the group.

The most often used approach that contrasts to having one person or a small group empowered to make decisions is having people of the wider group vote on matters that affect the group. Such a democratic process also stretches back thousands of years, with varying sizes of groups using this approach. A frequent difficulty that has arisen is the group controlling access to voting to only some members of the group, such that only certain people of the group are permitted to vote and thus only certain people's opinions are able to be expressed in the voting. As a result, improvements in voting techniques typically focus on making voting more accessible and easier for people, to ensure as many opinions are reflected in the vote as possible.

This approach to collecting a multitude of opinions is sometimes referred to as collecting the “wisdom of the crowd.” This concept is that while a small group may make poor decisions, a larger number of people may make better decisions as a result of any individual errors in decision making being suppressed through the scale of the vote. In theory, by making voting more accessible and easier, governance is naturally improved.

The inventors have recognized and appreciated, however, that while thousands of years have been spent on governance techniques, including on expanding access to voting to improve decision making, voting still results in poor decision making. The evidence of this abounds, with marked difficulties of late facing democracies around the world, from towns through countries. Decisions are not made better by expanding access to voting and making voting easier. Instead, turnout among the wider population often remains low despite the improvements in access. Thus, people of the group who can most easily vote are the ones who vote. Fundamentally, though, the people who can most easily vote may not be the ones who are informed or most informed about a topic, or most impacted by the topic, or otherwise involved. The people who vote may instead be uninformed about the topic, including unimpacted by the topic and thus unwilling or disinterested in becoming more informed. Rather than the “wisdom of the crowd,” the crowd that votes may lead to unwise decisions being made, leading to the poor voting results often seen and that can lead to a negative feedback cycle that further depresses voting turnout.

The inventors have recognized and appreciated that approaches to voting that have been used for thousands of years are fundamentally flawed. Voting approaches often give a single person a single vote, to ensure equality in voting. Even where time and effort is invested in improving voting, the one-person-one-vote equality principle remains. In addition, there is no “cost” to or need to expend resources on voting in traditional techniques. In fact, many approaches to voting removes costs as part of expanding access to voting, such as by removing poll taxes. Without any such cost, that the likelihood increases that anyone is and feels free to express an opinion on a topic even if the opinion is uninformed or if the vote has no impact on the person, which often occurs.

In contrast to the thousands of years of experience with voting and governance of a population, the inventors have recognized and appreciated that it would be advantageous if a population of members given a vote was also given a limited amount of a resource that could be “spent” on the voting. This limited resource could introduce a “cost” to voting, within the voting system, and make voters consider how important a particular vote is to them before “spending” any of that resource on voting. Introducing such a “cost” to voting may make voters self-select on whether to vote, potentially leading to people who are impacted by the subject of the vote being more likely to “spend” their resource to vote than other voters and potentially leading to unimpacted voters not voting or voting less, which may mean that uninformed voters do not vote or vote less and more informed voters vote. This has the potential to increase the likelihood of a well-informed decision being made for the population through the vote, given that the voters may be more informed than otherwise.

The inventors have recognized and appreciated that there may be a variety of ways to introduce a “cost” to voting, but the inventors have identified that an advantageous way in which to introduce a cost would be providing an amount of resource to be “spent” on voting that corresponds to an amplification of the voter's vote. A voter may be assigned an amount of a resource and may be assigned or earn more of the resource over time, and the voter can choose for a particular vote how much of the resource to “spend” or invest in the vote. When an amount of the resource is spent, that may directly impact how much the voter's vote “counts” in the vote or an amplification of the voter in the vote.

This approach of introducing cost and amplifying a vote based on the spent cost stands in stark contrast to the fundamental principle of one-person-one-vote and free voting that has persisted for thousands of years in most voting systems. The inventors have recognized and appreciated that this has the potential to improve quality of voting by not only introducing a cost to voting, but also amplifying a vote of voters who spend more of their resource to vote. This again may increase the likelihood of impacted and/or informed voters having a voice that is heard above and beyond other voters, since not only may they vote in greater numbers, but they may also spend more of their limited resource on that vote. Each voter may be free to choose over time and between votes, which votes to use their resources on, meaning that each voter may spend more resources on those votes where the subject of the vote matters to them more, or on which they are more informed, or by which they are more impacted. This can increase the likelihood of an outcome of a vote reflecting the best interests of the group, since the decision of the group may be impacted most by the people most impacted by (and hopefully most informed about) the outcome of vote.

In some embodiments described herein, a voting system may allow for, in a vote, each voter submitting a vote (or not) in a poll, and separately determining an amount of amplification to assign to that vote. The amplification may be an amount of weight linked to a vote, which could be reflected in some systems as additional votes or in other systems as a multiplier or other augmenter of a vote that affects how the vote is counted. In some such embodiments, a voter may vote and then may be permitted to add amplification or not to the vote. Subsequently, each vote and the amplification applied to each vote can be used to determine an outcome of the vote. In addition, in some embodiments the amount of amplification applied by each voter to their vote can be deducted from the voter's available amount of amplification, such that the amplification has been “spent” (or invested) in the vote and is not available for future votes. Some techniques for earning or being assigned more amplification are described below, for use in some embodiments. In examples described herein, clients may participate in voting, and clients may be associated with voters. For example, a client may be a device or software facility, and/or voting system account, associated with a voter. A voter may be a person, a member of an organization, an organization (in a case that organizations are collaborating among one another and each organization has a vote), and so on. Embodiments are not limited to operating with any particular voting context or any particular type of voter. Techniques described herein may be used in a variety of voting contexts.

Another problem inherent to voting is the difficulty to secure and authenticate the votes. Throughout history, there have been instances of ballot boxes being stuffed, ballots being changed, or votes being fraudulently submitted. Electronic voting has been touted as a possible solution, but electronic voting has its own problems of the electronic system being hacked and corrupted. The inventors have recognized and appreciated that conventional techniques for handling votes, including conventional security mechanisms, for decision making such as resource allocation are limited in their accuracy and fairness. For example, prior attempts at voting have attempted to use a centralized data store so that the votes are all in one secure storage for tallying.

However, the inventors have recognized that centralized storage may be inherently unreliable and also can breed distrust, as the centralized storage may be subject to perceptions that the centralized storage was manipulated. The inventors have recognized that efficiency and trustworthiness can be improved with a decentralized storage or a distributed storage. However, the inventors have recognized and appreciated that distributed techniques can be computationally inefficient and prone to manipulation by actors that alter the factors and issues based on which the resources are allocated.

The inventors have therefore recognized and appreciated that it would be advantageous to cryptographically secure a poll among distributed storage. For example, each vote can be secured in a hash chain that can be accessed by everyone or by voters so that they can see their vote in the chain. Each additional vote can be added to the hash chain so that the chain is tied to the preceding and the following votes in the chain. With some such hash chains, each of the clients or voting clients would be able to certify and verify their own vote from review of the hash chain so that the clients can ascertain the security of the whole vote chain.

The hash chain of some embodiments can be used for facilitating a cryptographically sealed sequence of votes. Each client may cryptographically seal and submit its vote into the sequence of votes. For example, the sequence of votes can be a blockchain, while each vote can be a block of the blockchain. The block can indicate the way in which the client voted, and the amplification amount applied to the vote. In some embodiments, the block may include additional parameters such as an issue to which the vote is applied, comments associated with the vote, or tax distribution selections indicating how resources are to be distributed.

In some embodiments that include a blockchain, the blockchain can be encrypted and secured with one or more keys. A private key for a block of the blockchain can be specific to the client to submit its vote. The client can use the private key to encrypt and generate its block, such as after voting. Each individual client can use its individual private key to make changes to its own block and authenticate its own block, or blocks in a case that each vote of a poll is associated with a different block of the blockchain and a client submits a vote in multiple polls. As each client uses its private key to generate a block, the blocks are combined into a blockchain. Each client can decrypt their own blocks of the blockchain and confirm that their vote has not been manipulated, meaning that over the population of clients voting in the poll, security of the poll can be ascertained and confidence in the accuracy of the poll built. A key for the blockchain can be used to decrypt the blockchain. The organization responsible for the vote (and/or, in some cases, the clients who voted) can decrypt the blockchain to the choices and amplification amounts applied to the vote by each of the clients that have submitted votes to determine an outcome of the poll.

In some embodiments, some techniques described herein can manage polls (e.g., elections) for the collection and synthesis of opinions, issues for the dissemination and collection of information, and allocations for distribution of resources. The polls, issues, and allocations can exist in the context of a realm. A realm may be a collection of voters/clients organized for a purpose, and to which one or more polls may relate. The realm may in some cases exist outside the context of the voting, such as where the realm is associated with a business, social organization, municipality, country, or other collection of people. In other cases, the realm may be assembled for a voting system and may not have an analog outside of the voting system. In some cases, a voter or client may belong to multiple realms, such as where a voter may belong to a realm for an employer and a realm for an organization with which the voter volunteers.

In some examples described herein, a realm may be referred to as an endeavor. An endeavor may be associated with a real-world context or not, but may instead reflect a collection of clients working together toward one or more goals or tasks.

Clients that are associated with a realm or an endeavor may in some cases be referred to as “members” of that realm or endeavor. As discussed in detail below, in some illustrative examples members may be compensated for contributions to a realm or endeavor with a share of the realm or endeavor's assets. Clients may in some cases become members of a realm or endeavor upon being invited to do so and/or being approved to join, and may leave or disassociate from a realm or endeavor voluntarily and/or in response to being dismissed by other members.

For example, in some embodiments, while clients can maintain consistent identities (e.g., profiles), clients can belong to one or more realms, which can be a multi-tenancy mechanism for handling sets (e.g., populations) of clients. For example, realms can organize different sets of connections between the same set of clients. In another example, each realm can be a group and/or a community. A client can be a member of multiple realms. For example, any given client can be a member of a company, a club, or a town. In other examples, the client can be a legal entity such as a business entity (e.g., corporation, company, etc.), an unincorporated entity (partnership, association, etc.), an organization, or family. Each organization can be represented by its realm that hosts discussions and decisions relevant to its clients.

Some techniques described herein can manage polls (e.g., elections, referenda, or other polls) as a decision-making framework for prioritizing what matters should command people's attention, voting for specific outcomes, or deciding when a poll should end.

In some embodiments, polls can be decided based on how each client applies amplification, which can be a “cost” imposed on voting. As discussed above, without amplification, polls can be decided by voting schemes that tally voters' preferences by summing them. For example, if one option has 6 votes and another option has 4, then that is the tally for the poll. That tally can be used to determine an outcome of the vote in a variety of ways. For example, the option with 6 votes wins in a winner-take-all. In another example, a party with 6 votes takes 6 seats and another party with 4 votes gets 4 seats in proportional representation. In such prior no-cost approaches, regardless of how the poll is decided, other than the time it takes to cast a vote, there is no cost to cast the vote in summed voting. While having no cost may be considered egalitarian insofar that it can encourage egalitarian (but not equal) expense for the voters, the poll may be categorized into any of the following: spam, coalitions, and sustained conflicts.

As should be appreciated from the foregoing, a poll may experience spam when summed voting has no means of discouraging people from voting frivolously on matters that do not or should not concern them, or from using voting amplification on one issue to force concessions on another unrelated issue. For example, this dynamic may be exploited cynically and to great destructive effect by political demagogues. Email spam may be an example analogy because the marginal cost of bulk spam approaches zero but is less than the expected value of someone interacting with the spam, there is no friction or disincentive to send out spam. Conversely, if the act of sending an email was gated by a cost or expense, spam email could cease to exist. Similarly, spam voting could be mitigated if there was a cost to vote.

A poll may experience coalitions because the vote of one can be inversely proportional to the number of people voting, so there may be an incentive to form coalitions that vote as blocs across issues. In order to act as a coherent whole that can hope to achieve at least some voting victories, coalitions may squelch the nuanced opinions and preferences of their constituents. A poll may experience sustained conflict when summed voting creates an inherently adversarial dynamic between coalitions (e.g., majorities and minorities) in which there are long-term winners and losers. People, even the supposed “winners,” may grow resentful of being in a situation that is only capable of producing suboptimal outcomes for all, rather than one where the people for whom an outcome truly matters most are the ones who get their desired outcome. When decisions and the disagreements around them cannot be addressed on a per issue basis, lasting coalitions may resort to political gamesmanship and resentments among people may calcify.

Imposing a cost to voting that is paid for with a carefully managed currency, such as the amplification (sometimes also termed “power” in some examples described herein) included in some embodiments, may address problems that arise in polls. In some embodiments, an amount of amplification in a poll or for a realm may be based on a number of clients that belong to that poll/realm. For example, as each client joins a poll/realm, the total amount of amplification in circulation within that poll/realm (e.g., the pool for the poll/realm) may be increased by a constant number (e.g., 100) or relative amount (e.g., a percentage or fractional increase) of units, or otherwise increased. In another example, the total amplification in circulation may be decreased by an amount or the same amount (e.g., a constant or relative amount, such as 100 units or a percentage/fraction) when a client leaves the poll/realm. In some embodiments, each client may be limited to a certain amount of amplification. For example, in one such embodiment, no client can ever have more than 100 units of amplification. In some embodiments, each client may initially be given an amount of amplification, and in some such embodiments the clients may be each be given the same amount of amplification. For example, each new client can initially be granted 3 units of amplification. In some cases, a new client may start with 0 units of amplification. In some cases in which a number of amplification units are added to an amount of available amplification when a new client joins a poll or a realm, the amount of amplification that is initially assigned to the joining client may be less than what was made available in the poll/realm, and the remaining amount may be made available in the poll/realm to be earned by others over time. For example, if 100 units of amplification are added to a realm when a client joins the realm, 3 units may be initially assigned to the client while the remaining 97 units are put into the realm pool.

In some embodiments, when a client applies amplification in a poll, in response to the “spending” of the amplification, some of that spent amplification may be distributed among the other clients in the poll or realm. For example, the amount of amplification that was spent by the client may be allocated among the other voters in the poll. Or as another example, an arbitrary amount of amplification in the realm pool may be distributed to an arbitrary set of other clients (and any remaining amount of spent amplification not in the arbitrary amount allocated back to the pool). In some such cases that amplification is not reallocated, the amplification may not be allocated back to the client spending the amplification and/or may not be allocated to clients that already have a maximum amount (e.g., 100 units) of amplification or otherwise satisfy a criterion for not being allocated additional amplification. As one particular example, if a client were to apply 4 units of amplification to its vote in a poll, other clients may each receive 2 units of amplification.

As one specific example of a manner of reallocating amplification that is spent by in a poll, each time one unit of amplification is spent by a client in a poll, that unit of amplification may be reassigned to another client of that poll, or of a discussion to which a poll relates (see below for description of discussions), or of a realm (e.g., endeavor) to which the poll relates, or otherwise to another member. The reallocation may be performed probabilistically in accordance with a likelihood assigned to each of the other clients at that time. Such a likelihood may be determined using a likelihood calculation formula that may be based on an amount of amplification currently held by the client (e.g., in general, in the discussion, in the realm, or otherwise), a maximum amplification that could be held by the client, a number of clients eligible to receive the amplification (e.g., number of members in the realm, in the discussion, or otherwise), and/or other factors. For example, the likelihood can be determined using the formula

$$L = ( ( A + 1 ) / M ) * 1 / C$$

where L is the likelihood being calculated, A is the amount of amplification currently held by the client, M is the maximum amount of amplification, and C is the number of clients eligible to receive amplification. A benefit of this formula is that as a client's amount of available amplification is drawn down and approaches zero (as a result of spending amplification voting), the first term ((A+1)/M) becomes smaller and the client has a smaller and smaller chance of being granted more amplification relative to other clients. This means that a client who has been recently highly active in spending amplification in voting, or recently spent a large amount of amplification when voting, may have a “cooling off” period where they no longer have the same power to vote and other clients may have a greater chance to influence outcome of a vote. This can again influence behavior of clients and ensure that they spend their amplification wisely and may spent their amplification on the issues that affect them the most or on which they are the most knowledgeable. It should be appreciated, however, that embodiments are not limited to operating with a particular formula.

In some embodiments, clients can vote multiple times in the same poll in the style of an auction.

While in some embodiments, an application of amplification to a vote in a poll by a client may lead to that vote being increased in weight in that poll by the amount of amplification, embodiments are not so limited. For example, in other embodiments, the impact of a client's amplification in any one poll other may not be linear and instead an amount of weight assigned to a vote may be less than an amount of the amplification. For example, the amplification may be negatively weighted in the vote, such that an amount of amplification resulting from the negative weighting may be used in determining an outcome of a vote. In embodiments that include such negative weighting, various weighting formulations may be used, some of which may include logarithmic and/or exponential weighting, such as quadratic weighting. As an example of negative weighting, to increase the tally for a given option by 2 points, a client would have to apply 4 units of amplification. Or, as another specific example, if a client tried to amplify their vote by 100, the weighting would be used to count that as only an amplification of 10, while in this example if a client tried to amplify their vote by 50 it may count as an amplification of 7. In these embodiments, the negative weighting can be used to prevent one person from swinging the outcome of the vote by spending all or a large amount of their amplification at one time.

In some embodiments, a client can apply amplification against another client's amplification. For example, the client can apply negative amplification (e.g., anti-power) to vote against and cancel out the amplification of a particular option in a poll. In some embodiments, when a client applies negative amplification, an amount of the amplification in the realm pool is distributed to other clients, but not to the client spending the amplification and not to clients that already have a maximum amount (e.g., 100 units) of amplification. For example, when a client applies 4 units of amplification against another client's amplification, the other clients may each receive 2 units of amplification. In some embodiments, the sum of all taxed amplifications and negative amplification that clients applied in a poll can determine the poll result. In some embodiments, amplification techniques provide a number of useful properties, such as from a game theory perspective. For example, voters can use amplification to not just express a preference, but also express a degree of preference. The amplification enables both majorities and minorities to determine an outcome of the poll, and “win” depending on how strongly each feels about the issues. The clients can apply amplification to collectively identify an outcome that reflects the net will of the group. For example, an auction-style poll allows voters to discover the outcome (e.g., price) for an issue based on their willingness to amplify (e.g., pay) for the outcome. In another example, the cost of applying amplification in one poll is the opportunity cost of not doing so in another, due to the limited nature of amplification. Since amplification can be finite (e.g., in a closed system) and can neither be bought nor sold nor used for anything other than voting, amplification may give every voter equal treatment/voice over time, if not on any one issue.

In some embodiments, amplification techniques can mitigate poll issues such as spam, coalitions, and conflict, discussed above. The cost of voting may incentivize clients to vote only or vote more on (or apply amplification to) issues that truly matter to them. For example, while some clients might squander amplification on frivolous votes, others may be incentivized not to do so by the desire to retain their amplification for future polls. The ability to apply more amplification on matters of greater importance to them may allow minority groups of clients to determine the outcome of the polls (e.g., win). For example, the minority group can win, and at times even at a low cost, when the majority elects not to vote at all on issues that may concern them less or not at all. Since minorities can win, then the amplification techniques may disincentivize clients to form coalitions. Without coalitions, sustained conflict between coalitions ceases to exist, and instead may scale down to the disagreement that arises between individual clients on individual issues. At this scale, however, the clients who collectively feel the strongest about a particular issue may be the ones more likely to get their way, thereby achieving the outcome at the lower bound of disagreement.

Amplification can be used in a variety of poll types, and amplification can be a common voting mechanism for the various types of polls. In some embodiments, the amplification techniques can be used to prioritize polls or issues. Clients can apply amplification to vote on the relative importance of any given poll or issue itself. For example, clients can use amplification to prioritize the occurrence of certain polls or visibility of certain issues. The mechanics of prioritization enables clients to apply amplification to upvote or downvote the poll or issue one or more times. Each vote can be taxed progressively.

In some embodiments, the amplification can be used to manage auctions, which can be polls that offer choices between multiple options. In some embodiments, the options may include predetermined options. In other embodiments, write-in options may be permitted, or voters may otherwise determine the options for votes during the voting or when submitting their vote. In some embodiments, the tallying of votes in the auction can be performed in a variety of ways. For example, the votes can be tallied based on winner-take-all. In another example, the votes can be tallied based on proportional representation. There may be one winning option in some votes, while in others there may be multiple winning options (e.g., a top “N” vote-getters may win). Embodiments are not limited to operating with any particular style of vote.

In some embodiments, a poll can be configured with time conditions (e.g., deadlines). For example, for the poll, the clients may need to determine an outcome (e.g., make decisions) within a specific timeframe. When the time condition is satisfied, a poll is closed, and no further votes can be cast. For example, if the time condition is a deadline, then the poll is closed after the deadline passes. In some embodiments, the configuration of the poll may be subject to voting, such as by permitting further votes on the deadline itself to be cast, potentially moving the deadline from the past back into the future and thereby reopening the poll. The deadline itself may be determined in a vote in which clients propose and vote on specific time conditions, and other conditions of a poll may be similarly voted on by clients who vote in the poll. For example, the time condition or other poll condition with the greatest the number of votes can be selected as an applicable condition for the poll. In some embodiments, the clients can apply amplification when voting on the poll conditions. For example, clients can apply more amplification to conditions of greater importance to them. The condition can be selected based on the amplification. For example, clients that want to vote on something urgently may apply a lot of amplification to a time condition to impose that time condition. If there is a tie among time conditions, or any other subject of a vote, one of the options may be selected in some polls. In a case of the time conditions, the earlier time condition may be selected.

Embodiments described herein can be used for voting in a variety of contexts for a variety of populations, to make different kinds of decisions for different populations. For example, the population can be employees of a corporation or citizens of a locality, region, or country. Embodiments described herein are not limited to use with a particular population of clients or type of clients, or to any particular type of poll of the clients of a population to decide on any particular type of issue.

Elections can be associated with issues, which can be the means by which clients collect and disseminate information. In some embodiments, any client who is participating in a population of clients who can vote on a subject (e.g., a realm) may create an issue. For example, an issue can include a title and text that describes the issue in detail. In another example, issues may include comments that can also be created by any client. Both issues and comments can be prioritized.

In some realms that contain more than a handful of clients, there may be a higher degree of voting activity and the number of issues and accompanying comments could become difficult for clients to track. In some embodiments, clients can follow or subscribe to other clients to follow and receive issues posted by those clients. In some embodiments, the system may ask the clients to specify or indicate which other clients they would like to subscribe or follow. The client can then receive a “newsfeed” of posts, upvote, or otherwise engagements with issues and comments made by those clients. The issues in the newsfeed can be sorted by a prioritization or ranking tally. The client may be able, in some embodiments, to upvote and downvote issues in the newsfeed. As clients downvote and upvote the issues in the newsfeed and comment on the issues, the issues and comments can be prioritized or ranked in the newsfeed according to the interactions. In some such cases, as a result of the prioritization or ranking, issues and comments that clients upvoted may be seen by more clients while issues and comments that clients downvoted may be seen be fewer clients.

The listing of issues in the newsfeed, and/or the prioritization/ranking of issues, may expose clients to new issues from other clients. As issues from clients in the realm are prioritized/ranked, they can be displayed to the clients in the realm. For example, clients can discover issues from clients with which they are separated by a first, second, and or n-th degree in the realm, where the degree of separation indicates of number of interpersonal connections separate the two people. By being exposed to issues and comments from other clients, clients can discover other clients and their viewpoints. The exposure to clients and their issues in a large realm can improve cohesiveness in a realm and allow clients to meet and interact with clients that they didn't previously know.

In some illustrative examples, when members of a realm or endeavor share information for the realm/endeavor, the information may be shared in a “discussion” related to the realm/endeavor, which may in some cases be a newsfeed, chatroom, or other stream of content related to the realm/endeavor. Members may be able to initiate a discussion for a realm or endeavor, or may be able to promote in the discussion content shared by other members. In some such cases, using some techniques described herein, an amount of information available to a member on their client may be ranked, filtered, prioritized, or otherwise organized to promote viewing by a member of content shared by certain other members of a discussion. These other members may be members to which a member has “subscribed.” For example, in some cases, a system may display in a newsfeed on a client operated by a member In some cases, when a member, via a client, invites another member to join a realm or endeavor and the invitation is accepted (and, in some cases, approved by other members via other clients), the members may become subscribed to one another in a discussion such that the members are more likely to see content posted in the discussion by the other or otherwise made available in the discussion in response to actions taken by the other member. In some embodiments, when a system is choosing what content to show to a member in a discussion, the system may choose content that was posted by another member to which the member is subscribed or that was (even if posted by another, including another member to which the member is not subscribed) promoted by such a member. In some cases, when content that has been shared in a discussion has been promoted (or “emphasized”) by one or more members, that could increase a likelihood of a system choosing to present that content to certain members. Accordingly, in some cases the content that is output for presentation to a particular member may be chosen based on that member's subscriptions and/or how much each available content has been promoted. In some embodiments in which a member can subscribe to other members, the member may be permitted to remove a subscription upon request to the system, or mute a subscription for a set period of time or until the mute is lifted to hide content from that member for a time.

In some cases in which clients can subscribe to each other or be subscribed to content distributed by other clients, there may be a limit on a number of subscriptions a client can have at one time. Embodiments are not limited to operating with a particular number and embodiments may use any suitable number. In some embodiments, the number may be 150, which is a number derived from social science suggesting a possible human psychological limit to social group size, sometimes referred to as Dunbar's Number. Other numbers are possible, though. In some such embodiments that include a maximum number of subscriptions, if a member would like to add a new subscription but is already at their maximum, then the member may be prevented from adding more subscriptions. In some embodiments, in response to a detection that a member has reached the maximum number of subscriptions and asked to add another, the newly-requested subscription may be added to a “wait list” of subscriptions and not added as a subscription until an opening is created through another member closing their account or the member removing an existing subscription. In other embodiments, in response to a detection that a member has reached the maximum number of subscriptions and asked to add another, a message may be output indicating that the maximum number of subscriptions has been reached and that to add the new subscription, and a prior subscription should be removed.

In some embodiments, members that have joined a discussion may be referred to herein as a discussion's participants and can leave a discussion upon requesting to leave the discussion, or can mute or suppress notifications regarding content shared in the discussion. Participants may also be able to engage in the discussion by sharing content or commenting on content shared by others. A discussion may have an initiator who started the discussion.

In some cases, polls may be linked to discussions, in that a participant in a discussion may ask the discussion's participants to make a decision by completing a poll. The decision may in some cases be a choice between two or more options. Such polls may be operated in accordance with techniques described herein, including in some cases by having participants vote on the manner in which a poll is to be conducted or the options that the participants are able to choose between. In accordance with techniques described herein, members may be able to amplify their votes in a poll by applying a certain amount of amplification (sometimes called “power”) to their vote, but may also be able to vote at least once (without amplification) without spending any of their accrued amplification. In some cases, an amount of amplification available to a client for a poll may be linked to the discussion to which a decision/poll relates. For example, if a member operating a client is involved in multiple discussions, the member may have a different amount of amplification available to them for each discussion. In other embodiments, a member of a client may have an amount of amplification available to them for each realm (e.g., endeavor) in which they are involved, regardless of how many discussions are ongoing for that realm. In still other embodiments, a member of a client may have an amount of amplification available to them regardless of realm, and may spend that amplification across realms.

The prioritization or ranking of issues in a newsfeed may determine whether some or all clients of a realm are notified of an issue, based on how other clients engage with that issue. By prioritizing/ranking the issues, it may be more likely for each issue be provided to and seen by a relevant audience of clients. For example, issues that are important to only a few will be seen by only a few, while issues that are important to many will be seen by many. For example, prioritization/ranking of issues may be an improvement over largescale decision frameworks that are purposefully designed for the lowest common denominator. In another example, prioritization/ranking of issues may be an improvement over rigid partitioning of decision makers by arbitrary groupings like cities, states, and federations. By prioritizing/ranking the issues, the audience and participating voters can be determined on a per issue basis and by the clients themselves.

In some embodiments, the described techniques can help populations of clients allocate resources. The techniques help fairly distribute the population's resources such that an individual has a share that is commensurate with the value provided to others. Meanwhile, the ability of individuals to accumulate lasting amplification to undermine others is prevented.

For example, the resources can represent items or rights to be allocated to the clients. As one particular example, the resources could represent water rights. One client may vote for water usage rights and trade a small share of resources if they already have a lot of water, while another client may need water usage rights and trade a larger share of resources if they are in a drought-stricken area. The distribution of resources allows for regulation of how a population focuses its attention, compensation, or individual and group behaviors. For example, the resources can be used to determine that the client managing the drought-stricken area is to be provided a greater number of resources corresponding to more water usage rights.

In some embodiments, allocation of resources may provide a variety of benefits. One potential benefit of resources is to determine the membership of a realm, as those receiving resources may be members of the realm or voting members of the realm. Another benefit may be determining distribution of a realm's resources. Distributing the realm's resources also provides many benefits. For example, managing the distribution of the realm's resources allows clients to regulate where a realm focuses its attention. In another example, managing the distribution of the realm's resources allows clients to regulate compensation. In another example, managing the distribution of the realm's resources allows clients to regulate beneficial and harmful individual and group behavior.

In some embodiments, a distribution of resources among the clients in a realm can be tracked by a stake that the client has in the realm, where some or all clients each have stake in the realm. This stake can represent each client's percent share of realm resources. For example, the stake can be a non-zero number indicating the percent share. In some such embodiments, the clients can manage their stakes like a personal budget. The client can request to distribute or assign their stake as they see fit. For example, the clients can hold on to their entire stake until they decide to distribute it to other clients. For example, resources in companies can be measured in fiat currency doled out as salary. However, unlike salary in a company that increases only when a manager decides that it should increase, in some embodiments a quantity of a client's stake may increase or decrease proportionally with the realm's success because a stake can be a percent share of the resources. While resources can be financial, they are not limited as such. As an example, resources can be bananas and the stake can be the share of bananas that each client gets to take home from a farm.

In some embodiments, clients can use stake to allocate resources amongst each other. For example, clients can use the stakes to distribute resources in a manner that may be considered fair, as the resources in proportion to the stake may also be in proportion to activity by clients in a realm. Stakes may help align incentives for the clients, even if the clients are not aligned on preferences. Stakes may allow clients in the realm to discuss and express tradeoffs in resources instead of operating from within the disjointed and often conflicting objectives of different and poorly coordinated managers. For example, some clients may believe that expending additional effort is worth the extra resources (e.g., bananas), while others may feel they have enough resources (e.g., bananas) and would prefer the extra free time.

In some embodiments, the stake is the sum of equity, taxes, tryouts, and negative equity. Equity can grant the client managing the equity a share of the realm's resources. Taxes can be paid by equity holders. Tryouts, discussed below, can be a way to induct new clients into the realm in some embodiments. Negative equity can allow clients to negate (e.g., downwardly adjust) another client's stake or to expel a client. In some embodiments, the stake of each client is made public in the realm. In some embodiments, the equity, taxes, and negative equity are also publicized in the realm. In some embodiments, tryouts are not publicized in the realm. In some embodiments, since stakes are publicized to the clients in the realm, the taxation of equity enables clients to make informed decisions about how their resources should be spent.

In some embodiments, clients may have equity in a realm, which may be associated with resources of the realm assigned and held by the client. For example, the first client of a realm could have 100% equity in the realm, but that may decrease as other clients earn or are given equity in the realm. In some embodiments that include equity, clients that hold equity may have privileges and obligations to the realm. For example, in some embodiments, equity assigned to a client indicates the corresponding percentage of the realm's resources assigned to that client. For example, a client with 10% of the realm's equity is entitled to 10% of the realm's bonus pool. Clients may be obligated to pay a tax on resources assigned as equity. For example, clients may be obligated to pay a 50% tax on resources received as equity transfers from other clients. In another example, if a client is given 100 units of resources by other clients, the client must distribute 50 units back into the realm. In some embodiments, clients can use their equity to issue tryouts. As further described below, clients can use tryouts to induct new clients into a realm. In some embodiments, clients can use their equity to issue negative equity. As further described below, negative equity can be used to allocate their equity against another client's equity to reduce their stake in the realm.

In some embodiments, equity may be transferrable to other clients of the realm. A client can request to transfer any portion of their equity to any other client. In some embodiments, the transfers are not reversible. For example, the client that requested the transfer of equity cannot later reverse the transfer to return the equity. However, the client that received the equity could decide to transfer the equity back to the sender.

In some embodiments that permit equity transfers, such equity transfers may be taxed, with some of the equity redistributed into the realm as a result of the taxing. For example, if the tax rate is 50%, then 50% of the equity transferred to a client is then redistributed back into the realm. In some embodiments, the tax rate is selected for the realm, so each client is taxed the same rate on their equity transfers. In some embodiments, while taxes can be mandatory in the realm, each client chooses exactly how their taxes are spent. In some embodiments, each client can select and change what percentage of their taxes go to which other client(s). For example, a client can select that their taxed equity be split evenly among two other clients. In some embodiments, the client cannot select themselves to receive their tax distribution. For example, the client cannot select to direct the tax amount back to themselves. Taxes can prevent a client from allotting resources to themselves. For example, taxes can remove the tension of giving someone a raise at one's own expense and creates a system of compensation that dynamically allocates resources to clients who deliver value to their peers. In another example, clients' profits are commensurate with the value they deliver as judged by the clients to whom the value is delivered.

For example, taxing equity transfers may leverage demand by increasing a likelihood that what a client works on is perceived as delivering value to the clients who pay for that work. In some embodiments, the taxation may create a market in which there is only demand-side pricing and no supply-side pricing. For example, in the digital world (e.g., digital assets), the marginal cost of goods may approach zero. In another example, in the labor market, the number of hours each client has to work may be assumed to be generally equal and constant. In the aforementioned examples, supply-side pricing may be an attack vector for manipulation. For example, clients might end up directing resources (e.g., work) towards things that are not useful even if compensated work is a form of public service. A problem may arise when clients are incentivized by resources (e.g., directed to work by dollars) rather than by what the realm of clients (e.g., public) wants and needs. In some embodiments, by eliminating supply-side pricing, efforts may be better aligned between how clients spend their resources and with what's useful to other clients.

In some embodiments, clients can use tryouts to add other new clients to the realm and may assign equity to new clients on a tryout basis. For example, any client (or set of clients) can request to use some (e.g., an arbitrary percentage) of their equity as a tryout to induct a new client. For example, a client can tryout a transfer a tenth of their equity to a new client being added to the realm. In some embodiments, unlike some other equity transfers that may not be changeable after the transfer or may only be changeable when one or more conditions are met, tryout equity can be increased, decreased, or canceled altogether. For example, the client can transfer more of their equity to increase the tryout equity assigned to the new client, decrease the tryout equity assigned to the new equity to transfer back some equity, or cancel the tryout equity altogether and receive all the equity back from the new client. In some such cases, the existing client may continue to be taxed on their entire amount of equity (e.g., including whatever amount is transferred as tryout equity). In other cases, though, the existing client may cede tax distribution decision making and the corresponding stake to the new client. The tryout equity can create a transient hierarchy where the existing client has hiring power and thus some economic and therefore at least some political authority over newly inducted clients. However, transfer of equity by the existing client may create economic limits and pressure such that transferring equity at a certain point is greater than what the existing client can afford, let alone prefer. For example, transfers of equity can erase hierarchical links between clients.

In some embodiments, equity transfers and tryout equity can be different from just using taxes or polls. For example, taxes apply to the transfer while tryout equity fairly distributes the costs and benefits of inducting a new client to the existing client adding the new client. Tryout equity can mitigate against an existing client attempting to overwhelm other clients by inducting many new clients. For example, without tryout equity, an existing client could add new clients to stage a coup by poll numbers against other clients. However, the tryout equity limits the new power of the new clients to prevent coups.

Clients in the realm can carry costs in the form of stake they are assigned and political risk in wielding authority. Conversely, these costs can also be benefits as clients in the realm can contribute to the total share of realm resources or lighten the load to help make better decisions. For example, weighing the costs and benefits can be contentious in companies that hire, or in countries that take in immigrants, at least in part because the costs and benefits often go to different sets of people. In another example, the benefits go to one set and the costs go to another. In another example, managers in organizations may hire rampantly to inflate their own departments while the rest of the company pays the costs of the hires, reducing the opportunity for other departments to grow. In countries, people who do not benefit from immigration can cut off companies' supply of high skill labor, which potentially holds back entire national economies while imposing human costs.

Tryouts can address the costs inherent to adding new clients by requiring that those who believe an induction of a new client will be beneficial to pay for it from their own equity. For example, small businesses similarly work and definitionally avoid suffering from administrative bloat, vanity hiring, or other value destroying forms of headcount growth. For example, if a business believes that someone will add more value than it will cost to hire them, then the business will hire them. Otherwise, the business should not hire them. Embodiments of value are not limited an increase in resource production. Value could be decided by the clients in the realm, so value could be defined to be environmental or workplace culture. It could be that an added client will simply reduce the workload, a tradeoff a business or client might understandably want to make. However, through some techniques described herein, such a hire is not a tradeoff that someone who will not benefit from the decreased workload will be forced to pay for. Tryouts of equity can allow clients to enforce this balance between costs and benefits.

If any client could induct or add additional clients at no cost, the realm could experience a coup. For example, the coup could be in the form of a fake client attack, sometimes also called a “Sybil” attack. In another example, a client could induct an army of cronies or fake clients (including real users that are not legitimate members of a realm but rather only inducted to enable power accumulation by one client) that overrun the existing clients' voting power. Using polls to induct new clients requires an upfront power outlay but a client could still setup a poll to induct a new client with a deadline that is unreasonably short and do so repeatedly or recursively until the realm is overrun. It could be difficult to unwind such an event to restore the realm membership to its form before the coup. Stop gap measures such as rate limiting, imposing deadline minimums, or creating hiring committees could come with their own disadvantages that could either make decision making less nimble or create administrative power that is distinct from power that can be used to hijack a realm. Polls can enable simple collective decisions, while negative equity can be a suitable mechanism for identifying the decision makers. Splitting political power and realm membership can help alleviate the challenges of inducting new clients. While realm power inflates with each new client, there can be a consistent amount (e.g., 100%) of a realm's equity that can be used to modulate realm membership.

In some embodiments, clients can apply negative equity against other clients. Clients can apply negative equity to expel or censure a client that they believe is harmful. Negative equity can be a useful mechanism for clients to affect clients to which they have neither allocated taxes nor tryout equity and therefor do not have the ability to return (e.g., rescind) equity. Clients can use negative equity to redistribute equity (e.g., wealth) from a client who is believed to be holding too much (e.g., an unjust amount) of the equity in the realm. For example, negative equity can help avoid that inflated political power cannot be used to overrun the view of the majority of equity holding clients 115. In another example, negative equity prevents clients for hoarding equity because past a certain point, tryouts go upside down on tax obligations and distributing at least 50% of the equity to other clients becomes an inevitability.

A client, in some embodiments, can allocate any portion of their equity against another client. The negative equity can reduce the other client's equity. In some embodiments, negative equity do not alter the components of stake, but they can deduct from the final sum that makes up a client's stake. For example, the negative equity can be a 1:1 reduction so applying 5 units of negative equity to another client will reduce that client's equity by 5 units. The deducted portion of equity can be redistributed from the client to which the negative equity is applied to other clients in the realm. For example, the deducted portion can be redistributed pro rata. The client that applies the negative equity can also be prevented from using that equity for tryouts or equity transfers.

In some embodiments, when the negative equity applied to a client exceeds their remaining equity, the client can be expelled from the realm. For example, since negative equity decreases the client's stake, too much negative equity can cause a client's stake to decrease below an expulsion threshold (e.g., 0). When the client's stake decreases below a threshold, the client can be expelled from the realm and whatever equity they had can be redistributed pro rata to everyone in the realm.

In some embodiments that may grant a share of equity in a realm to clients that are members of the realm, the equity may accrue in units generated over time. For example, in a unit of time (e.g., one hour, 15 minutes, 6 hours, or other unit of time) one unit of equity (which might be considered akin to a “share” of a realm) may be generated. Ownership of that equity unit may then be fractionalized according to a client's stake share in the realm (or a stake of a member that is associated with the client). For example, if a client has a 0.15 stake share, that client may receive an additional 15% of one equity unit every unit of time, such that the client's overall stake increases by 0.15 equity units every unit of time.

In some embodiments, a client's equity stake can be redeemed by a client at a time. For example, an equity stake may correspond to a percent ownership of the assets held by a realm at a time. The percentage ownership or ownership share of the client could be determined based on the number of equity units held by the client and the total number of equity units issued for the realm or still in circulation or valid, such as by dividing the client's number of equity units by the total number of equity units. The equivalent value of the stake may be obtainable by the client in some cases, such as by obtaining a monetary value in real-world currency equal to that client's share of the real-world currency value of the realm's assets. In some embodiments, rather than receiving a true equivalent value to the client's share of equity, a realm may have a set “redemption rate” that identifies a conversion between equity units in a realm and a real-world currency, and the redemption rate may be used to determine the conversion from equity units to real world currency value. In some embodiments (including some operating with a redemption rate), rather than the real world value being a currency, the value may be expressed in other real world units such as units of a non-currency resource (e.g., crops grown/harvested, manufactured goods, or other output from a realm, water, or other real-world resources). In some embodiments that permit redemption of equity for real-world value, the redemption may void the redeemed units of equity and take them out of circulation.

In some embodiments, when a client has a share of equity in a realm, the client may be able to transfer some or all of that equity to another, including clients who are members of a realm or, in some embodiments, to clients who are not members of a realm.

In some embodiments that operate with granting clients an amount of stake in a realm, or an amount of stake share to be allocated to a client each time a unit of equity is generated, the determination of the amount may be made by an allocation decision/poll. In some such cases, an allocation/decision poll may be open to all clients that are members of a realm. In other embodiments, a selected group of clients may make the determination. In some such embodiments, the selected group of clients may be a randomly selected group, who may be randomly selected from clients that are members of a realm or randomly selected from a group consisting of clients having a certain level of connectedness in the realm to the client for which the determination is being made. As an example of such levels of connectedness, the degrees of connection/separation between clients may be considered using subscriptions, such that clients that are subscribed to one another are first-degree connections, a first client that is subscribed to a second client that is in turn connection to a third client is a second-degree connection of the third client, and so on. In some cases, individual clients may be randomly selected from among a set of candidate clients, but the set of candidate clients may be set to have a certain cross-section of membership of a realm. For example, a number N of first-degree connections may be chosen, a multiple of N (e.g., 2N) of second-degree connections may be chosen, a larger multiple of N (e.g., 4N) of third-degree connections may be chosen, and so on. In some cases, the larger multiples may be set using a consistent multiplier (e.g., multiply again by a set value, e.g., 2, in each iteration).

In some embodiments in which a cross-section of clients may be chosen for a decision/poll, the cross-section of clients may be chosen by first conducting a breadth-first search of a set of clients whose members are eligible to vote in the decision/poll. The breadth-first search may start with an initiator of a decision/poll for which a cross-section is to be taken, who may in some cases be the person starting the decision/poll, a person particularly affected by the decision/poll (e.g., someone whose stake is to be adjusted), or other person. In such a case, a graph of connections between members may be walked in the breadth-first search, starting with the initiator. In the breadth-first search, all clients whose members have a direct connection (e.g., members to which the initiator is subscribed) in the realm or endeavor may be identified and compiled for a list of members, which is a set of first-degree connections. Next, for each one of those members the connections may be gathered, which collectively produces a set of second-degree connections. Then for each of those members on the second-degree connection list the connections are gathered, yielding a number of third-degree connections. This continues until every member of the realm or endeavor is listed. In some embodiments, each member is listed only once and in the level at which they are first eligible to be listed, while in other embodiments a member may be listed at each level at which they are eligible to be listed and thus may be listed multiple times. Once every member is listed at least once, the listed is finalized. A random selection of increasing size (e.g., as described above) may then be taken of each level until the desired jury size is reached or a sample from every level is taken.

In some cases in which an allocation decision/poll is operated, there may be a quorum on votes. The quorum may in some embodiments be based on the identity of the clients selected to participate in the allocation poll, including in a case that less than all clients in a realm are participating in the decision. For example, to ensure that a cross-section of the clients of the realm participate in a key vote (e.g., to determine how much equity stake or stake share to grant a client), a quorum may be that more indirect connections of the client being evaluated (indirect connections being second or greater connections) vote than the number of direct connections, to limit the chances of a set of clients merely rewarding a friend rather than acting in the interest of the realm. As another example, a quorum may be that a multiple (e.g., twice) the number of indirect connections vote than direct connections. Other quorums are possible.

Such allocation decisions/polls may be conducted to increase or decrease a particular clients stake or stake share. In some embodiments, such an allocation decision/poll may be conducted to expel or dismiss a client from a realm or suspend a client's privileges or interactions with a realm, to temporarily or permanently disassociate the client from the realm. In some embodiments, a determination of whether to invite a client to join the realm or accept a client's application to join a realm may be performed with an allocation decision. In a case in which a decision is with respect to a client that is not a member of a realm, some of the determinations above (regarding clients to choose to participate in an allocation, or a quorum) may be based on an initiator of an allocation (e.g., the client inviting another client to join) or an initiator of a realm or discussion, rather than based on the client being considered for membership.

In some embodiments, the systems and methods for handling the techniques described herein include one or more parameters. In some embodiments, the tax rate can be set based on self-interest of the taxpayer and the interest of the realm receiving the taxes. For example, the tax rate can be 50%. In some embodiments, the max amplification can be a constant. In some embodiments, the max amplification can be the amount of amplification in the realm to be divided among the clients. The max amplification can be set to an exact number that is large enough to provide granularity in strength of preference and small enough for people to be able to reason about it. For example, the max amplification can be 100. In some embodiments, the initial amplification can be the amount of amplification (e.g., units) initially assigned to the realm. For example, the initial amplification can be 3 units, which can be the minimum number needed to allow 2 or more clients to start spending amplification without ever knowing with certainty how much amplification the other client has. In some embodiments, the probability of distributing more amplification from the pool can be based on a constant technique. For example, the probability can be based on an unbiased Bernoulli distribution. In some embodiments, an expulsion threshold can define the stake when there is no support for a client to remain in a realm. When the stake for a client satisfies the threshold, the client's equity is too low, and the client can be expelled from the realm. For example, the expulsion threshold can be set to 0.

In some embodiments, the system and methods described herein can enable a civic model for pure direct democracy that mitigates against concentrations of political power and creates a distribution of economic power that is proportional to the value each client is perceived to deliver. The clients can participate in the activities of the realm whenever they want. For example, there is no mandatory civic duty. Clients can affect decision making in their realm by using amplifications, allocating taxes, and distributing their equity. Conversely, clients that do not allocate their taxes or do not wield their amplification is effectively deferring to the aggregate opinion of those who do for as long as they sit back. For example, clients benefit from the systems and methods described herein by having a rightsized administrative overhead to create the greatest amount of good for the largest number of clients while harming the fewest number of clients the least.

Some illustrative implementations of the techniques described herein are set out below in connection with the figures. It should be appreciated that embodiments are not limited to operating in accordance with any of these examples, as other embodiments are possible.

### Hardware Components of Some Embodiments

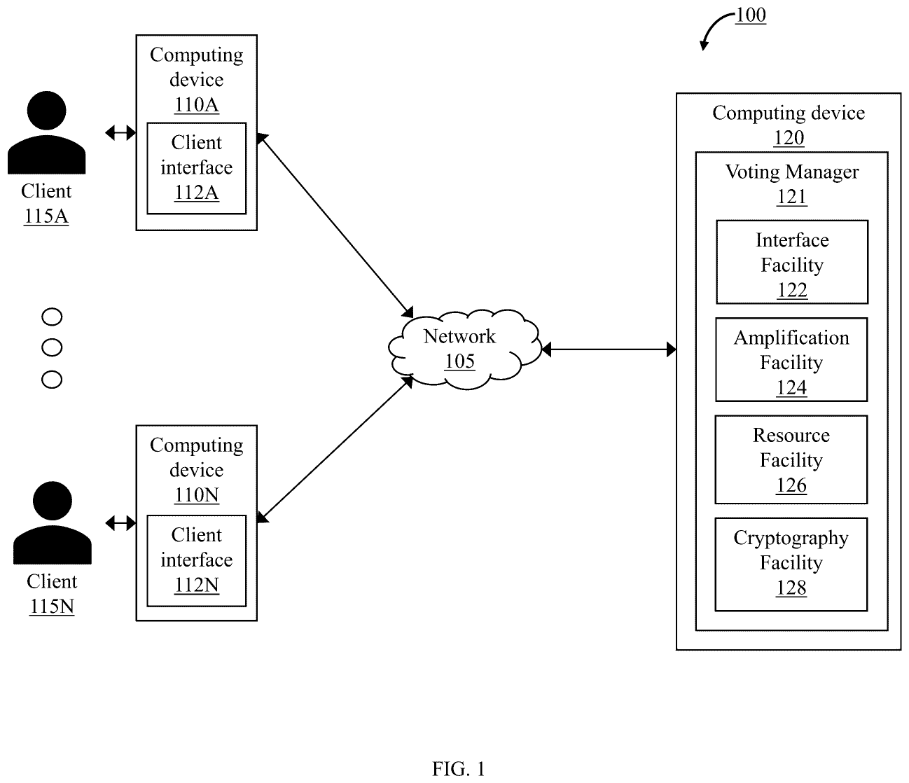

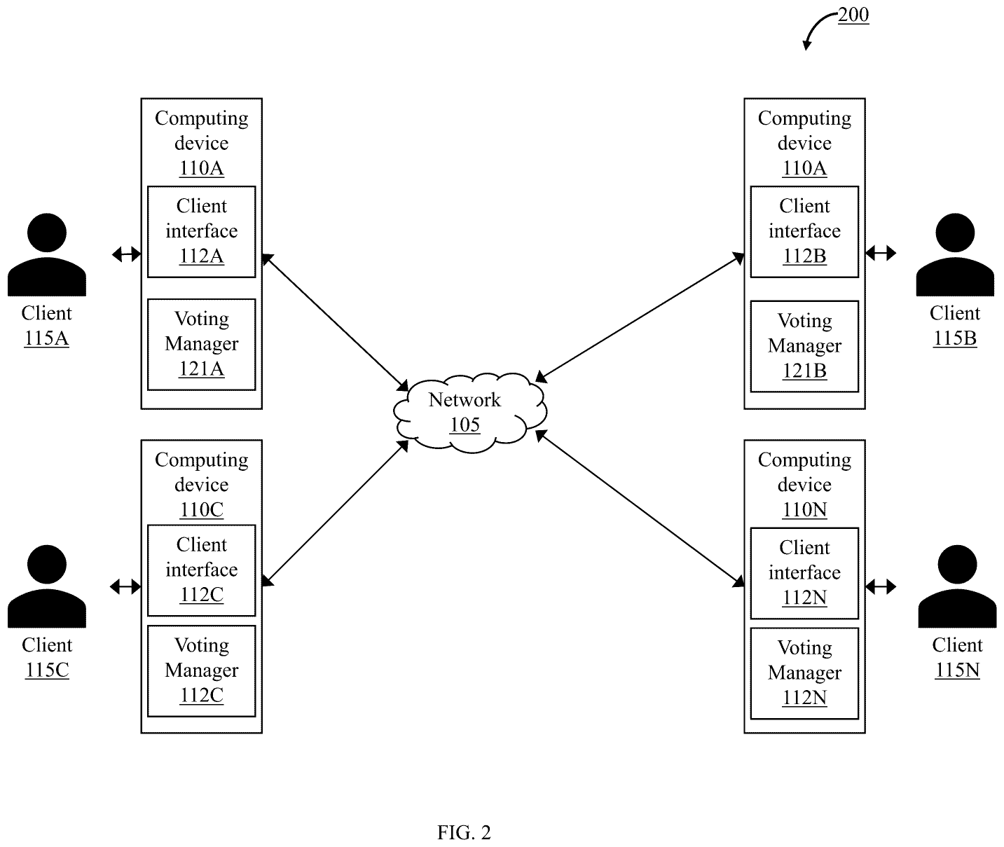

FIG. 1 is a block diagram of an example system 100 for managing voting, in accordance with some embodiments of the technology described herein. In the illustrative example of FIG. 1, system 100 includes a network 105, a plurality of computing devices 110A-110N that each include a client interface 112 for interfacing with a respective client 115A-115N, a computing device 120 including a voting manager 121 that includes an interface facility 122, an amplification facility 124, a resource facility 126, and a cryptography facility 128. In the illustrative example of FIG. 2, system 200 is a decentralized system without computing device 120. System 200 includes the network 105, a plurality of computing devices 110A-110N that each include a client interface 112 for interfacing with a respective client 115A-115N and the voting manager 121 for handling voting. In some embodiments, the clients 115A-115N collectively form a realm in which they collectively use the techniques described herein to make decisions.

It should be appreciated that system 100 is illustrative and that a system may have one or more other components of any suitable type in addition to or instead of the components illustrated in FIG. 1 and FIG. 2. For example, there may be additional remote systems (e.g., two or more) present within a system. It should also be appreciated that in some embodiments, the system 100 may include classical computing hardware that is configured in any architecture. Such other hardware may include one or more central processing units (CPUs) and/or graphics processing units (GPUs), such as a distributed array of CPUs and/or GPUs that are configured to interoperate and execute portions of a task in parallel.

The network 105 may be or include one or more local and/or wide-area, wired and/or wireless networks, including a local-area or wide-area enterprise network and/or the Internet. Accordingly, the network 105 may be, for example, a hard-wired network, a wireless network (e.g., connected over Wi-Fi and/or cellular networks), a cloud-based computing network, or any combination thereof. For example, in some embodiments, the computing device 110 and the computing device 120 may be located within the same building or building complex and connected directly to each other or connected to each other via the network 105, while in some embodiments, the computing device 110 may be located in a remote building and connected to the computing device 120 through the network 105. In some embodiments, the computing device 110 and the computing device 120 are integrated as one device.

The computing device 110 may be any suitable one or more electronic devices configured to send instructions and/or information to the computing device 120, to receive information from the computing device 120, and/or to process obtained data. In some embodiments, computing device 110 may be a fixed electronic device such as a desktop computer, a rack-mounted computer, or any other suitable fixed electronic device. Alternatively, the computing device 110 may be a portable device such as a laptop computer, a smart phone, a tablet computer, or any other portable device that may be configured to send instructions and/or information to the computing device 120, to receive information from the computing device 120, and/or to process voting related data.

The computing device 110 can include the client interface 112 for interfacing with a client 115. The client 115 can use the computing device 110 to access and/or utilize the systems and methods described herein. In some embodiments, the client interface 112 includes graphical user interfaces. In some embodiments, the client interface 112 includes executable instructions. The client 115 can interact with the client interface 112 to control or configure the computing device 110 or the computing device 120. In some embodiments, client 115 can use the client interface 112 to view data generated by the computing device 120.

The computing device 120 may be any suitable one or more electronic devices configured to send instructions and/or information to the computing device 110, to receive information from the computing device 110 and/or the quantum annealer 130, and/or to process obtained data. In some embodiments, the computing device 120 may be a fixed electronic device such as a desktop computer, a rack-mounted computer, or any other suitable fixed electronic device. In some embodiments, the computing device 110 may be a portable device such as a laptop computer, a smart phone, a tablet computer, or any other portable device that may be configured to send instructions and/or information to the computing device 120, to receive information from the computing device 120, and/or to process voting related data.

The voting manager 121 can include the interface facility 122. The interface facility 122 can display interfaces on the computing device 110 for the client 115. In some embodiments, the interface facility 122 can manage interfaces for defining a poll among the clients 115. In some embodiments, the interface facility 122 can manage interfaces for managing voting among the clients 115. In some embodiments, the interface facility 122 can manage interfaces for managing cryptographic voting among the clients 115. In some embodiments, the interface facility 122 can manage interfaces for determining outcomes from cryptographic voting among the clients 115. In some embodiments, the interface facility 122 can manage interfaces for managing auction voting among the clients 115. In some embodiments, the interface facility 122 can manage interfaces for prioritizing or ranking issues among the clients 115. In some embodiments, the interface facility 122 can manage interfaces for managing amplification for voting among the clients 115. In some embodiments, the interface facility 122 can manage interfaces for managing realm resources among the clients. In some embodiments, the interface facility 122 can manage interfaces for managing shares of resources among the clients. In some embodiments, the interface facility 122 can manage interfaces for managing resource transfers among the clients 115. In some embodiments, the interface facility 122 can manage interfaces for managing taxes on resources among the clients 115. In some embodiments, the interface facility 122 can manage interfaces for managing new clients 115. In some embodiments, the interface facility 122 can manage interfaces for negating equity.

The voting manager 121 can include the amplification facility 124. In some embodiments, the amplification facility 124 can receive a vote from each client 115 submitting a vote and separately receive an amount of amplification to assign to that vote. The amplification may be an amount of weight linked to a vote. The amplification facility 124 can amplify the vote as a multiplier or other augmenter of a vote that affects how the vote is counted. In some embodiments, the amplification facility 124 may receive, from the client 115, a vote and an amplification to the vote. Subsequently, each vote and the amplification applied to each vote can be used by the amplification facility 124 to determine an outcome of the vote. In some embodiments, the amount of amplification applied by each client 115 to their vote can be deducted from the available amount of amplification of the client 115, such that the amplification has been “spent” (or invested) in the vote and is not available for future votes.

The voting manager 121 can include the resource facility 126. The resource facility 126 can track the distribution of resources among the client 115 in a realm by identifying an individual stake that clients 115 have in the realm. This stake may represent the percent share of realm resources of the client 115. For example, the stake can be a non-zero number indicating the precent share. In some embodiments, the resource facility 126 can manage, for each client 115, stakes like a personal budget. The resource facility 126 can receive requests from the client 115 to distribute or assign their stake. The resource facility 126 can distribute or assign the stake based on the request. For example, the resource facility 126 can maintain the stake of the client 115 until they decide to distribute it to other clients 115.

The voting manager 121 can include the cryptography facility 128. In some embodiments, the cryptography facility 128 can secure each vote in a hash chain. In some embodiments, the cryptography facility 128 can publish each vote in the hash chain for access by the clients 115. For example, the clients 115 can access the hash chain to see their vote in the chain. The cryptography facility 128 can add each additional vote to the hash chain so that the chain is tied to the preceding and the following votes in the chain. The cryptography facility 128 can generate the hash chain for the clients 115 to certify and verify their own vote so that the clients can collectively ascertain the security of the whole vote chain.

The cryptography facility 128 can generate the hash chain for facilitating a cryptographically sealed sequence of votes. The cryptography facility 128 can receive, from each client, cryptographically sealed votes for submission into the sequence of votes. In some embodiments, the cryptography facility 128 can generate the sequence of votes in a blockchain, with each vote can be a block of the blockchain. The cryptography facility 128 can generate each block to indicate the way in which the client voted, and the amplification amount applied to the vote. In some embodiments, the cryptography facility 128 may generate the block to include additional parameters such as an issue to which the vote is applied, comments associated with the vote, or tax distribution selections indicating how resources are to be distributed.

The cryptography facility 128 can encrypt and secure the blockchain with one or more keys. The cryptography facility 128 can provide a private key for the blockchain that is specific to the client 115 to submit its vote. The cryptography facility 128 can receive the private key from the client 115 to encrypt and generate a block for the vote of the client 115. The cryptography facility 128 can receive private keys from each individual client 115 to make changes to its block and authenticate its block. As the cryptography facility 128 receive a private key from the client to generate a block, the cryptography facility 128 can combine the blocks into a blockchain.

The cryptography facility 128 can publish a public key for the clients 115 in the realm, or that voted, to decrypt the blockchain. The cryptography facility 128 can use the public key to decrypt the blockchain to see how each client 115 has voted. In some embodiments, the cryptography facility 128 can allow each client 115 (e.g., and the organization they represent) to decrypt the blockchain to the choices and amplification amounts applied to the vote. By decrypting the blockchain, the amplification facility 124 can use the votes and the amplifications to determine an outcome of the poll.

### Defining Polls

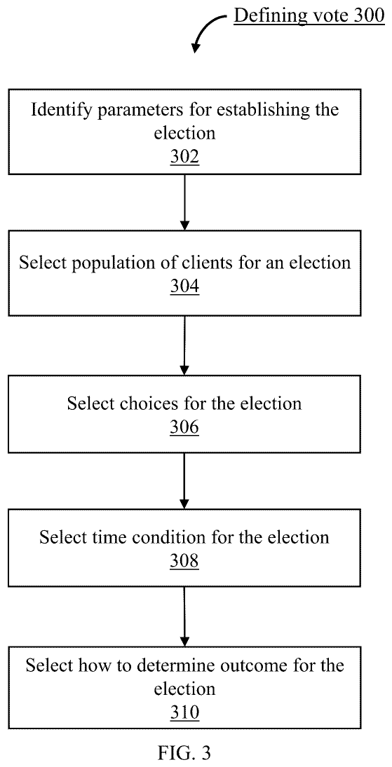

FIG. 3 illustrates a method 300 of defining a poll among the clients. The method 300 may be performed by the voting manager 121. At step 302, the voting manager 121 can identify parameters for establishing the poll. Any of the illustrative parameters described herein may be set for a poll. In some cases, as mentioned above, the parameters themselves may be the basis of a poll, such as when a realm votes on the parameters with which to run a poll. The voting for the parameters may be completed before a poll to be run in accordance with the parameters is conducted, or in some cases the members of a realm may be permitted to vote on the parameters before and/or during a poll to be run in accordance with the parameters, such as in a case that members vote to extend a poll's timeline. In other cases, rather than the clients voting on the parameters, the voting manager 121 can additionally or alternatively specify one or more parameters for the poll. In some embodiments, the voting manager 121 can define a tax rate to balance self-interest of the taxpaying client 115 and the interest of the other clients 115 in the realm receiving the taxes. For example, the tax rate can be 50%.

In some embodiments, the voting manager 121 can define a max amplification for the poll, which may be the maximum amount of amplification that can be applied in the poll. In other embodiments, the voting manager 121 can define the max amplification to be the amount of amplification in the realm to be divided among the clients 115. In some embodiments, the voting manager 121 can define the max amplification to be an exact number that is large enough to provide granularity and small enough for people to be able to reason about it. For example, the voting manager 121 can define the max amplification to be 100.

In some embodiments, the voting manager 121 can define initial amplification to be the amount of amplification (e.g., units) initially assigned to the realm. For example, the voting manager 121 can define the initial amplification to be 3 units, which can be the minimum number needed to allow 2 or more clients 115 to start spending amplification without ever knowing with certainty how much amplification is assigned to the other client 115.

In some embodiments, the voting manager 121 can define the probability of distributing amplification from a pool of amplification, such as when additional voters join a poll or realm in which a poll is being conducted, based on a constant technique. For example, the probability can be based on an unbiased Bernoulli distribution.

In some embodiments, the voting manager 121 can define an expulsion threshold to define the stake when there is no support for a client 115 to remain in a realm. When the stake for a client 115 satisfies the threshold, the client's equity is too low and the voting manager 121 can remove the client 115 from the realm. For example, the expulsion threshold can be set to 0.

At step 304, the voting manager 121 can select a population of clients 115 for the poll. In some embodiments, the voting manager 121 can receive requests from clients 115 to setup a poll. In some embodiments, an administrator assigns clients 115 into a realm. Voting can, of course, be used in a variety of contexts for a variety of populations, to make different kinds of decisions for different populations. For example, the population can be employees of a corporation or citizens of a locality, region, or country. Embodiments described herein are not limited to use with a particular population of clients or type of clients, or to any particular type of poll of the clients of a population to decide on any particular type of issue.

In some embodiments, a population of clients can be called a realm. While clients 115 can maintain consistent identities (e.g., profiles), clients 115 can belong to one or more realms, which can be a multi-tenancy mechanism for handling sets (e.g., populations) of clients 115. For example, realms can organize different sets of connections between the same set of clients 115. In another example, each realm can be a group and/or a community. A client 115 can be a member of multiple realms. For example, any given client 115 can be a member of a company, a club, or a town. In other examples, the client can be a legal entity such as a business entity (e.g., corporation, company, etc.), an unincorporated entity (partnership, association, etc.), an organization, or family. Each organization can be represented by its realm that hosts discussions and decisions relevant to its clients 115.

At step 306, the voting manager 121 can select choices for the poll. For example, the choices can be between managerial candidates. In some embodiments, the choices are predetermined while in other embodiments, the choices are write-in options or free choice by voters. In some embodiments, the voting manager 121 can receive requests from clients about the choices to put into the poll. In some embodiments, an administrator assigns choices that the clients 115 can choose in the poll. In other cases, the choices for a poll may be results of a prior poll (e.g., a primary election with a larger number of candidates from which a smaller number of candidates are chosen).

At step 308, the voting manager 121 can select time conditions for the poll. For example, the voting manager 121 can select a number of rounds for the poll (e.g., top vote getters compete in a run-off election). In some embodiments, the voting manager 121 adds time conditions (e.g., deadlines) to the poll. For example, the clients may need to determine an outcome (e.g., make decisions) within a specific timeframe. When the time condition is satisfied, the voting manager 121 can close the poll so that no further votes can be cast. For example, if the time condition is a deadline, then the voting manager 121 can close the poll after the deadline passes.

In some embodiments, the voting manager 121 can receive votes on the deadline itself, or other parameters of the poll. With enough votes, the voting manager 121 can potentially move the deadline from the past back into the future and thereby reopen the poll. In some embodiments, the voting manager 121 can receive the votes on the deadline in an auction in which the clients 115 propose and vote on specific time conditions. For example, the time condition with the greatest the number of votes can be selected by the voting manager 121.

In some embodiments, the clients 115 can apply amplification when voting on the time conditions. For example, clients 115 can apply more amplification to time conditions of greater importance to them. The time condition can be selected by the voting manager 121 based on the amplification. For example, clients 115 that need to vote on something urgently may apply a lot of amplification to a time condition to impose that time condition. If there is a tie among time conditions, the earlier time condition can be selected by the voting manager 121.

At step 310, the voting manager 121 can determine how to select an outcome for the poll. In some embodiments, the voting manager 121 can determine to select an outcome based on amplification. In some embodiments, the voting manager 121 can determine to select an outcome based on an auction.

### Managing Polls

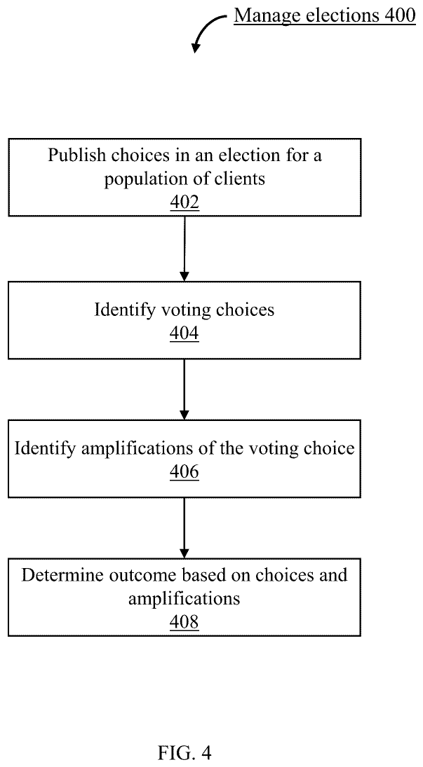

FIG. 4 illustrates a method 400 of managing polls among the clients. The method 400 may be performed by the voting manager 121. The method 400 may be performed by the voting manager 121. At step 402, the voting manager 121 can publish choices in an election for a population of clients 115. For example, the voting manager 121 can publish the choices in the client interface 112 for presentation to the clients 115. In some embodiments, the voting manager 121 can identify that clients 115 applied amplification to vote on the relative importance of any given poll. For example, clients 115 can use amplification to prioritize the occurrence of certain poll.

At step 404, the voting manager 121 can identify voting choices. In some embodiments, the voting manager 121 can receive selections of the voting choices from the clients 115.

At step 406, the voting manager 121 can identify amplifications of the voting choices. In some embodiments, the voting manager 121 can receive selections of how much amplification the clients 115 are requesting to apply to their votes. Amplification can be used in a variety of poll types, and amplification can be a common voting mechanism for the various types of polls. In some embodiments, polls can be decided by the voting manager 121 based on how each client 115 applies amplification. The voting manager 121 can limit how much amplification can be applied by each client 115. The amplification can be a cost imposed on voting.

In some embodiments, amplification techniques provide a number of useful properties, such as from a game theory perspective. For example, voters can use amplification to not just express a preference, but also express a degree of preference. The amplification enables both majorities and minorities to determine an outcome of the poll, and win depending on how strongly each feels about the issues. The clients 115 can apply amplification to collectively identify the optimal outcome that reflects the net will of the group. For example, an auction-style poll allows voters to discover the optimal outcome (e.g., price) for an issue based on their willingness to amplify (e.g., pay) for the outcome. In another example, the cost of applying amplification in one poll is the opportunity cost of doing so in another. Since amplification can be finite (e.g., in a closed system) and can neither be bought nor sold nor used for anything other than voting, amplification can give every voter a completely equal voice over time but not on any one issue.

In some embodiments, amplification techniques can mitigate poll issues such as spam, coalitions, and/or conflict. The cost of voting can incentivize clients 115 to vote only on issues that truly matter to them. For example, while some clients 115 squander their power on frivolous votes, most will not be incentivized to do so. The ability to apply more amplification on matters of greater importance may allow minority groups of clients 115 to determine the outcome of the polls (e.g., win). For example, the minority group can win, and at times even at a low cost, when the majority elects not to vote at all on issues that don't really concern them. Since minorities can win, then the amplification techniques disincentivize clients 115 to form coalitions. Without coalitions, sustained conflict between coalitions ceases to exist, and instead scales down to the disagreement that arises between individual clients 115 on individual issues. At this scale, however, the clients 115 who collectively feel the strongest about a particular issue are the ones who get their way, thereby achieving the outcome at the lower bound of disagreement.

At step 408, the voting manager 121 can determine an outcome of the poll based on the voting choices and the amplifications. In some embodiments, the voting manager 121 can weigh the voting choices based on how much amplification is applied to the voting choices. The voting choices are thus amplified, and the outcome of the poll can be the voting choice that is the most amplified rather than the vote that was selected by the greatest number of clients 115.

### Cryptographic Voting

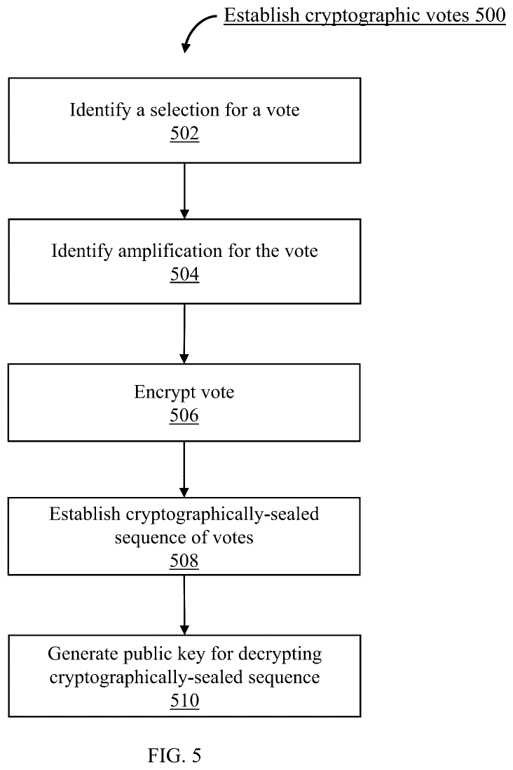

FIG. 5 illustrates a method 500 of managing cryptographic voting among the clients 115. The method 500 may be performed by the voting manager 121. At step 502, the voting manager 121 can identify a choice for a vote. In some embodiments, the voting manager 121 can receive selections of the voting choices from the clients 115. In some embodiments, the voting manager 121 can provide a private key for the blockchain that is specific to the client 115 to submit its vote. The voting manager 121 can receive the private key from the client 115 to encrypt and generate a block for the vote of the client 115. The voting manager 121 can receive private keys from each individual client 115 to make changes to its block and authenticate its block. As the voting manager 121 receive a private key from the client to generate a block, the voting manager 121 can combine the blocks into a blockchain.

At step 504, the voting manager 121 can identify amplification for the vote. In some embodiments, the voting manager 121 can receive selections of how much amplification the clients 115 are requesting to apply to their votes. In some embodiments, polls can be decided by the voting manager 121 based on how each client 115 applies amplification. The voting manager 121 can limit how much amplification can be applied by each client 115. The amplification can be a cost imposed on voting.

At step 506, the voting manager 121 can encrypt the vote. The voting manager 121 can encrypt each vote in a hash chain. In some embodiments, the voting manager 121 can publish each vote in the hash chain for access by the clients 115, or at least the clients 115 that voted in the poll. For example, each client 115 can access the hash chain to see its vote in the chain. The voting manager 121 can add each additional vote to the hash chain so that the chain is tied to the preceding and the following votes in the chain. The voting manager 121 can generate the hash chain for the clients 115 to certify and verify their own vote so that the clients as a whole can ascertain the security of the whole vote chain.

At step 508, the voting manager 121 can establish cryptographically-sealed sequence of votes. The voting manager 121 can generate the hash chain for storing a cryptographically sealed sequence of votes. The voting manager 121 can receive, from each client, cryptographically sealed votes for submission into the sequence of votes. In some embodiments, the voting manager 121 can generate the sequence of votes in a blockchain, with each vote can be a block of the blockchain. The voting manager 121 can generate each block to indicate the way in which the client voted, and the amplification amount applied to the vote. In some embodiments, the voting manager 121 may generate the block to include additional parameters such as an issue to which the vote is applied, comments associated with the vote, or tax distribution selections indicating how resources are to be distributed.

At step 510, the voting manager 121 can generate a public key for decrypting the cryptographically-sealed sequence of votes. The voting manager 121 can encrypt and secure the blockchain with one or more keys. The voting manager 121 can publish a public key for all the clients 115 in the realm to decrypt the blockchain. The voting manager 121 can use the public key to decrypt the blockchain to see how each client 115 has voted.

Determining Outcomes from Cryptographic Voting

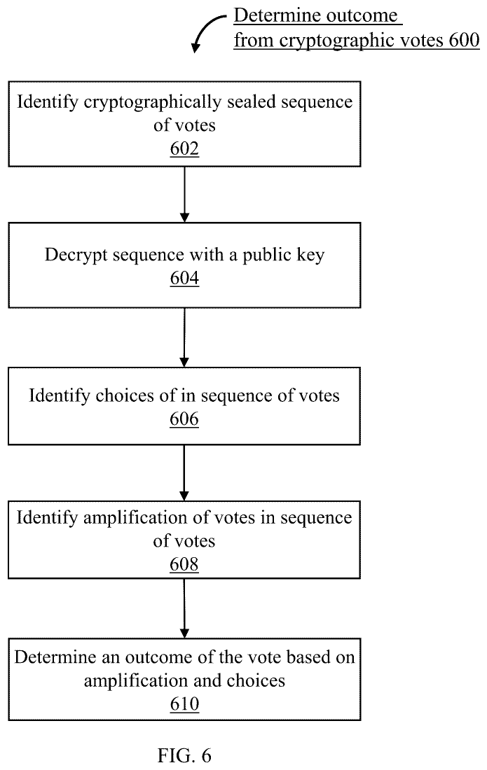

FIG. 6 illustrates a method 600 of determining outcomes from cryptographic voting among the clients. The method 600 may be performed by the voting manager 121. At step 602, the voting manager 121 can identify a cryptographically-sealed sequence of votes. In some embodiments, the voting manager 121 can identify a hash chain for storing a cryptographically sealed sequence of votes. In some embodiments, the voting manager 121 can identify a public key in the realm to decrypt the blockchain.

At step 604, the voting manager 121 can decrypt the cryptographically-sealed sequence of votes with the public key. The voting manager 121 can use the public key to decrypt the chain to see how each client 115 has voted.

At step 606, the voting manager 121 can identify choices in a sequence of votes. In some embodiments, the voting manager 121 can use the public key decrypt the chain to see how each client 115 has voted. In some embodiments, the voting manager 121 can allow each client 115 (e.g., and the organization they represent) to decrypt the blockchain to identify the voting choices in the poll.

At step 608, the voting manager 121 can identify amplifications of choices in the sequence of votes. In some embodiments, the voting manager 121 can use the public key decrypt the chain to see how each client 115 amplified their vote. In some embodiments, the voting manager 121 can allow each client 115 (e.g., and the organization they represent) to decrypt the blockchain to identify the amplification amounts applied to the vote.

At step 610, the voting manager 121 can determine an outcome of the vote based on the amplification and the choices. By decrypting the blockchain, the voting manager 121 can use the votes and the amplifications to determine an outcome of the poll. In some embodiments, the voting manager 121 can weigh the voting choices based on how much amplification is applied to the voting choices. The voting choices are thus amplified, and the outcome of the poll can be the voting choice that is the most amplified rather than the vote that was selected by the greatest number of clients 115.

### Auction Voting

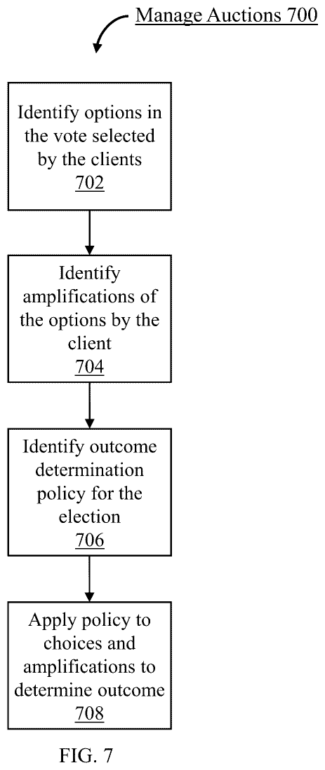

FIG. 7 illustrates a method 700 of managing auction voting among the clients. The method 700 may be performed by the voting manager 121. At step 702, the voting manager 121 can identify options in the vote selected by the clients. For example, an auction-style poll allows voters to discover the optimal outcome (e.g., price) for an issue based on their willingness to amplify (e.g., pay) for the outcome.

At step 704, the voting manager 121 can identify amplifications of the options by the clients. In some embodiments, the voting manager 121 can use the amplification to manage auctions, which can be polls that offer choices between multiple options.

At step 706, the voting manager 121 can identify how to determine an outcome for the poll. In some embodiments, the tallying of votes in the auction can be performed in a variety of ways. For example, the votes can be tallied by the voting manager 121 based on winner-take-all. In another example, the votes can be tallied by the voting manager 121 based on proportional representation.

At step 708, the voting manager 121 can determine the outcome based on the choices and amplifications. For example, if one option has 6 votes and another option has 4, then that is the tally for the poll. That tally can be used to determine an outcome of the vote in a variety of ways. For example, the option with 6 votes wins in a winner-take-all. In another example, a party with 6 votes takes 6 seats and another party with 4 votes gets 4 seats in proportional representation.

### Prioritizing Issues

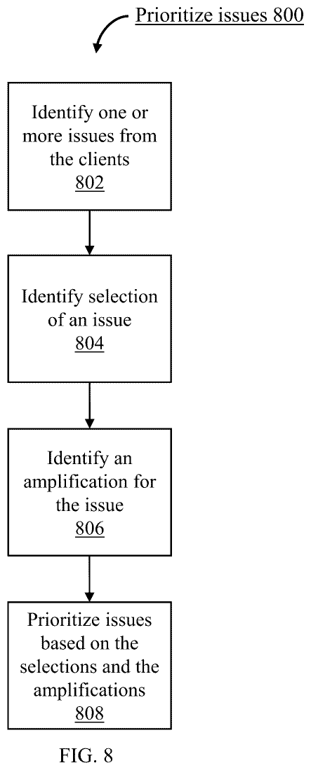

FIG. 8 illustrates a method 800 of prioritizing issues among the clients. The method 800 may be performed by the voting manager 121. At step 802, the voting manager 121 can identify one or more issues from the clients 115. Polls can be associated with issues, which can be the means by which clients 115 collect and disseminate information. Any client 115 can create an issue for the voting manager 121. For example, an issue can include a title and text that describes the issue in detail. In another example, issues can include comments that can also be created by any client 115. Both issues and comments can be prioritized.

In a realm that contains more than a handful of clients 115, the number of issues and accompanying comments can easily become overwhelming for the clients 115 to track. In some embodiments, the clients 115 can follow or subscribe to other clients 115 to follow and receive issues posted by those clients 115. In some embodiments, the voting manager 121 requests clients to specify or indicate which other clients 115 they would like to subscribe or follow. The voting manager 121 can then provide a newsfeed of posts, upvote, or otherwise engagements with issues and comments made by those clients 115. The voting manager 121 can sort the voting issues in the newsfeed by the prioritization tally.

At step 804, the voting manager 121 can identify a selection of an issue. The voting manager 121 can receive, from the client, an upvote or a downvote for the issues in the newsfeed. As various clients 115 downvote and upvote the issues and comments, the issues and comments can be prioritized by the voting manager 121 for display in the newsfeed to the clients 115. The voting manager 121 can cause issues and comments that clients 115 upvoted to be seen by more clients 115 while issues and comments that clients 115 downvoted to be seen be fewer clients 115.

At step 806, the voting manager 121 can identify an amplification for the issue. In some embodiments, the amplification techniques can be used to prioritize issues. Clients can apply amplification to vote on the relative importance of any given issue. For example, clients can use amplification to prioritize the occurrence of certain issues. The voting manager 121 can handle prioritization of issues to enable clients 115 to apply amplification to upvote or downvote the poll or issue one or more times. Each vote of the clients 115 can be taxed progressively by the voting manager 121.

At step 808, the voting manager 121 can prioritize issues based on the selections and the amplifications. The prioritization of issues by the voting manager 121 can expose clients to new issues from other clients 115. As issues from clients 115 in the realm are prioritized by the voting manager 121, they can be displayed to the clients 115 in the realm. For example, clients 115 can discover issues from clients 115 with which they are separated by a 1st, 2nd, and or n_th degree. By being exposed to issues from other clients 115, clients 115 can discover other clients 115 and their viewpoints. The exposure to clients 115 and their issues in a large realm can improve cohesiveness and allow clients 115 to meet and interact with clients 115 that they didn't previously know.

The prioritization of issues by the voting manager 121 determines whether some to all clients 115 of a realm to see an issue based on how clients 115 engage with that issue. By prioritizing the issues, it is more likely for each issue be provided to and seen by a right-sized and relevant audience of clients 115. For example, issues that are important to only a few will be transmitted by the voting manager 121 to only a few clients 115, while issues that are important to many will be transmitted by the voting manager 121 to many clients 115. For example, prioritization of issues may be an improvement over largescale decision frameworks that are purposefully designed for the lowest common denominator. In another example, prioritization of issues may be an improvement over rigid partitioning of decision makers by arbitrary groupings like cities, states, and federations. By prioritizing the issues, the voting manager 121 can determine, based on input from the clients 115, the audience and participating voters on a per issue basis.

### Amplification

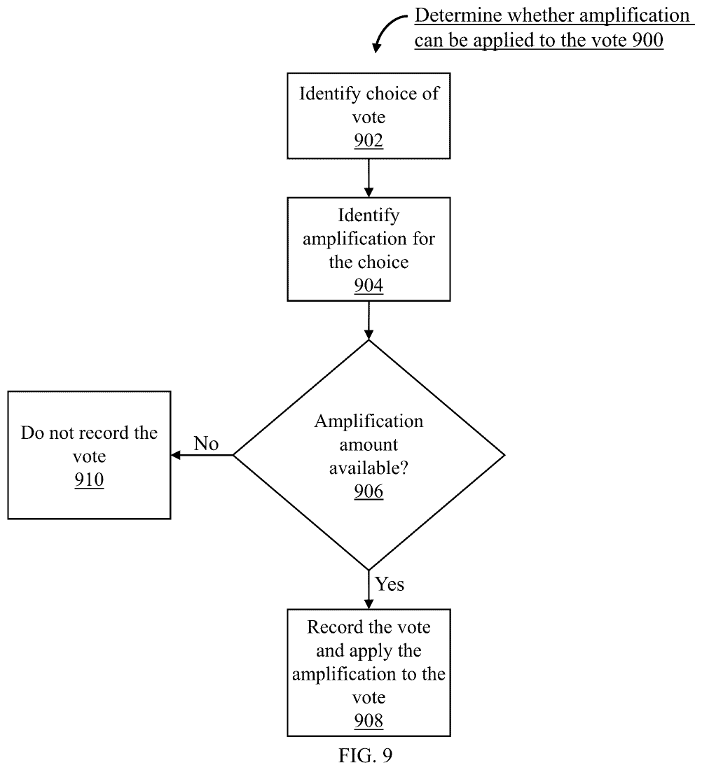

FIG. 9 illustrates a method 900 of managing amplification for voting among the clients. The method 900 may be performed by the voting manager 121. At step 902, the voting manager 121 can identify a choice of a vote. In some embodiments, the voting manager 121 can receive selections of the voting choices from the clients 115.

At step 904, the voting manager 121 can identify the amplification for the choice. In some embodiments, the voting manager 121 can receive selections of how much amplification the clients 115 are requesting to apply to their votes. In some embodiments, the amplification can be a cost to voting that is paid for with a carefully managed currency. For example, the amplification may be an amount or a unit to address problems inherent to basic polls. In some embodiments, the amplification in the realm is based on the clients 115 that belong to that realm. For example, as each client 115 joins a realm, the total amount of amplification in circulation within that realm (the realm pool) is increased by a constant number (e.g., 100) of units. In another example, the total amplification in circulation is decreased by the same amount (e.g., 100 units) when a client 115 leaves the realm.

At step 906, the voting manager 121 can determine whether the client has the amplification amount available. In some embodiments, each client 115 may be limited to a certain amount of amplification. For example, no client 115 can ever have more than 100 units of amplification. In some embodiments, each client 115 is initially given the same amount of amplification. For example, each new client 115 can initially be granted 3 units of amplification, while the remaining 97 units are put into the realm pool. In some embodiments, when a client 115 applies amplification in a poll, an arbitrary amount of amplification in the realm pool is distributed to an arbitrary set of other clients, but not to the client spending the amplification and not to clients 115 that already have a maximum amount (e.g., 100 units) of amplification. For example, when a client applies 4 units of amplification, the other clients may each receive 2 units of amplification.

In some embodiments, clients can vote multiple times in the same poll in the style of an auction. In some embodiments, the impact of a client's amplification in any one poll is taxed quadratically. For example, to increase the tally for a given option by 2 points, a client would have to apply 4 units of amplification.

In some embodiments, a client can apply amplification against another client's amplification. For example, the client can apply negative amplification (e.g., anti-power) to vote against and cancel out the amplification of a particular option in a poll. In some embodiments, when a client applies negative amplification, an amount of the amplification in the realm pool is distributed to other clients, but not to the client spending the amplification and not to clients that already have a maximum amount (e.g., 100 units) of amplification. For example, when a client applies 4 units of amplification against another client's amplification, the other clients may each receive 2 units of amplification. In some embodiments, the sum of all taxed amplifications and negative amplification that clients applied in a poll can determine the poll result.

If the amplification amount is available, then at step 908, the voting manager 121 can record the vote and apply the amplification to the vote. For example, each client 115 can initially be granted 3 units of amplification, and if the voting manager 121 determines that the client 115 has applied 3 or less units of amplification to the vote, then the voting manager 121 record the vote. Conversely, if the voting manager 121 determines amplification amount is unavailable, then at step 910, the voting manager 121 does not record the vote. For example, if the client 115 has used up their amplification, then the vote is not recorded. The client 115 may be permitted to vote again with a different amount of amplification, such as less than or equal to an amount of the amplification available to the client 115.

The limited amount of amplification available to each client 115 limits how much power they can exert over the polls. However, embodiments are not limited to determining whether a used unit amount of amplification is less than a limit on amplification, as other conditions may be used. For example, clients may be limited to how much amplification they can apply to a single vote or issue. In another example, clients may be limited to applying a fraction of their available amplification to the vote or issue. In yet another example, clients may be limited to how much amplification can be applied based on how much amplification was applied by other clients.

### Allocations

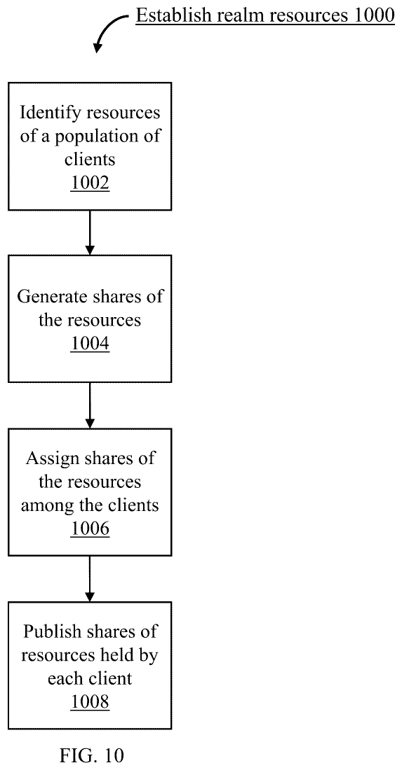

FIG. 10 illustrates a method 1000 of managing realm resources among the clients. The method 1000 may be performed by the voting manager 121. At step 1002, the voting manager 121 can identify resources of a population of clients 115. In some embodiments, the voting manager 121 can help populations of clients 115 allocate resources. The voting manager 121 can distribute the population's resources such that each client 115 has a share that is commensurate with the value provided to other clients 115. Meanwhile, the ability of individual clients 115 to accumulate lasting power to undermine other clients 115 is prevented.

At step 1004, the voting manager 121 can generate shares of the resources. For example, the shares of resources can represent items or rights to be allocated to the clients 115.

At step 1006, the voting manager 121 can assign shares of the resources among the clients. For example, the resources can represent water rights. One client 115 may vote for water usage rights and trade a small share of resources if they already have a lot of water, while another client 115 may need water usage rights and trade a larger share of resources if they are in a drought-stricken area. The distribution of resources allows for regulation of how a population focuses its attention, compensation, or individual and group behaviors. For example, the resources can be used to determine that the client 115 managing the drought-stricken area is to be provided a greater number of resources corresponding to more water usage rights.

At step 1008, the voting manager 121 can publish shares of the resources held by each client. The allocation of resources by the voting manager 121 can provide a variety of benefits. One benefit of resources is to determine the membership of a realm. Another benefit of resources is to determine the distribution of a realm's resources. Distributing the realm's resources by the voting manager 121 also provides many benefits. For example, the voting manager 121 managing the distribution of the realm's resources allows clients to regulate where a realm focuses its attention. In another example, the voting manager 121 managing the distribution of the realm's resources allows clients 115 to regulate compensation. In another example, the voting manager 121 managing the distribution of the realm's resources allows clients 115 to regulate beneficial and harmful individual and group behavior.

### Stakes

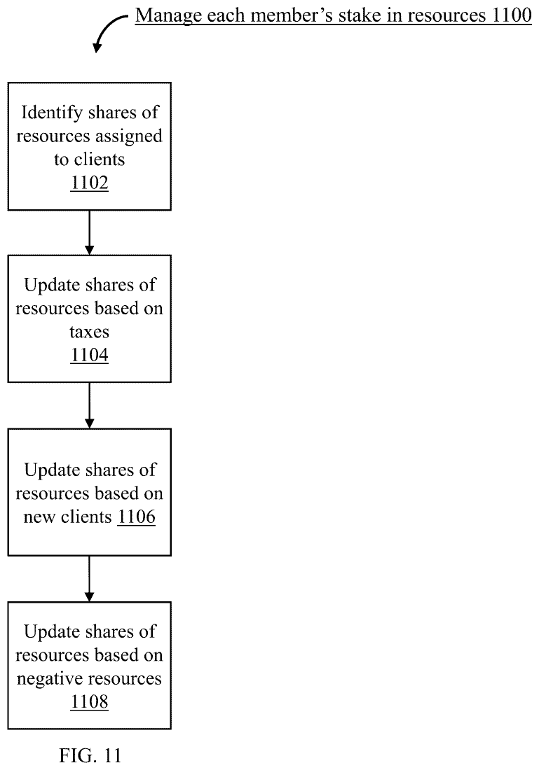

FIG. 11 illustrates a method 1100 of managing shares of resources among the clients 115. The method 1100 may be performed by the voting manager 121. At step 1102, the voting manager 121 can identify shares of resources assigned to clients 115. The distribution of resources among the clients 115 in a realm can be tracked by the voting manager 121 calculating a stake for every client 115 in the realm. The stake can represent each client's percent share of realm resources. For example, the stake can be a non-zero number indicating the percent share. In some embodiments, the clients 115 can manage their stakes like a personal budget.

The client 115 can request the voting manager 121 to distribute or assign their stake as they see fit. For example, the clients 115 can hold on to their entire stake until they decide to distribute it to other clients 115. For example, resources in companies can be measured in fiat currency doled out as salary. However, unlike salary in a company that increases only when a manager decides that it should increase, the actual quantity of a stake by the client 115 can increase or decrease proportionally with the realm's success because a stake can be a percent share of the resources. While resources can be financial, they are not limited as such. For example, resources can be bananas and the stake can be the share of bananas that each client 115 gets to take home from a farm.

The voting manager 121 can enable clients 115 to use the stakes to allocate resources amongst each other. For example, the clients 115 can request the voting manager 121 to use the stakes to fairly distribute resources. Stakes can help align incentives for the clients 115, even if the clients 115 are not aligned on preferences. Stakes allow clients 115 in the realm to discuss and express tradeoffs in resources instead of operating from within the disjointed and often conflicting objectives of different and poorly coordinated managers. For example, some clients 115 may believe that expending additional effort is worth the extra resources (e.g., bananas), while others may feel they have enough resources (e.g., bananas) and would prefer the extra free time.

In some embodiments, the voting manager 121 can compute the stake by identifying the sum of equity, taxes, tryouts, and negative equity. Equity can grant the client managing the equity a share of the realm's resources. At step 1104, the voting manager 121 can updates the shares of the resources based on the taxes. Taxes can be paid by equity holders. At step 1106, the voting manager 121 can updates the shares of the resources based on new clients. Tryouts can be a way to induct new clients into the realm. At step 1108, the voting manager 121 can updates the shares of the resources based on negative equity. Negative equity can allow clients to negate (e.g., downwardly adjust) another client's stake or to expel a client. In some embodiments, the stake of each client is made public in the realm. In some embodiments, the equity, taxes, and negative equity are also publicized in the realm. In some embodiments, tryouts are not publicized in the realm. In some embodiments, since stakes are publicized to the clients in the realm, the taxation of equity enables clients to make informed decisions about how their resources should be spent.

### Equity

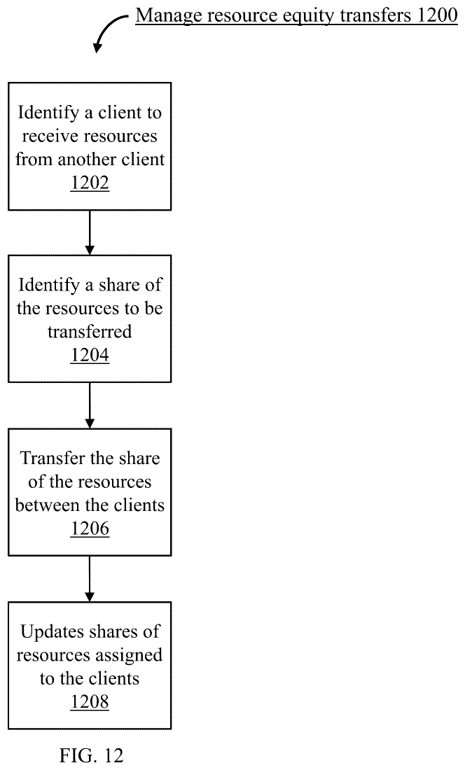

FIG. 12 illustrates a method 1200 of managing resource transfers among the clients 115. The method 1200 may be performed by the voting manager 121. At step 1202, the voting manager 121 can identify a client 115 to receive resources from another client 115. Equity can be shares of the resources assigned and held by the client 115. For example, the first client 115 of a realm would have 100% equity in the realm. Clients 115 that hold equity can have privileges and obligations. In some embodiments, equity assigned by voting manager 121 to a client 115 can indicate the corresponding percentage of the realm's resources assigned to that client 115. For example, a client 115 with 10% of the realm's equity is entitled to 10% of the realm's bonus pool.

At step 1204, the voting manager 121 can identify a share of the resources to be transferred. In some embodiments, clients 115 can request the voting manager 121 use their equity to issue tryouts. As further described below, clients can use tryouts to induct new clients 115 into a realm. In some embodiments, clients 115 can use their equity to issue negative equity. As further described below, negative equity can be used to allocate their equity against another client's 115 equity to reduce their stake in the realm.

At step 1206, the voting manager 121 can transfer the share of the resources between the clients 115. Equity can be transferred to other clients 115. A client 115 can request the voting manager 121 to transfer any portion of their equity to any other client 115. In some embodiments, the transfers are not reversible. For example, the client 115 that requested the transfer of equity cannot later cause the voting manager 121 to reverse the transfer to return the equity. However, the client 115 that received the equity could decide to transfer the equity back to the sending client 115.

At step 1208, the voting manager 121 can update the share of the resources assigned to the clients. Clients 115 may be obligated to pay a tax on resources assigned as equity. For example, clients 115 may be obligated to pay a 50% tax on resources received as equity transfers from other clients 115. In another example, if a client 115 is given 100 units of resources by other clients 115, the client 115 must distribute 50 units back into the realm.

### Taxes

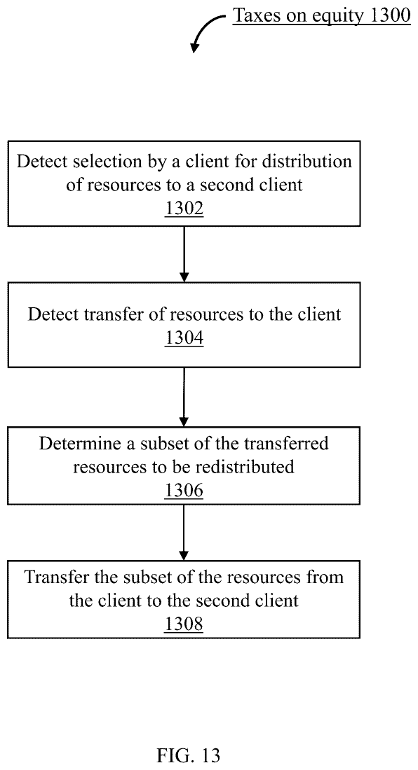

FIG. 13 illustrates a method 1300 of managing taxes on equity among the clients 115. The method 1300 may be performed by the voting manager 121. At step 1302, the voting manager 121 can detect selection by a client 115 for distribution of equity to a second client 115. The voting manager 121 can handle the taxation of equity transfers. The voting manager 121 can redistribute a subset of the equity into the realm based on the tax rate. For example, if the tax rate is 50%, then 50% of the equity transferred to a client 115 is then redistributed back into the realm. In some embodiments, the tax rate is selected for the realm, so each client 115 is taxed the same rate on their equity transfers. In some embodiments, while taxes can be mandatory in the realm, each client 115 can indicate via the voting manager 121 to which clients 115 their taxed equity is distributed. In some embodiments, each client 115 can select and change what percentage of their taxes go to which client 115. For example, a client 115 can select, via the voting manager 121, that their taxed equity be split evenly among two other clients 115.

In some embodiments, the client 115 cannot select themselves to receive their tax distribution. For example, the client 115 cannot select to direct the tax amount back to themselves. Taxes can prevent a client 115 from allotting equity to themselves. For example, taxes can remove the tension of giving someone a raise at one's own expense and creates a system of compensation that dynamically allocates equity to clients 115 who deliver value to their peers. In another example, clients' 115 profits are commensurate with the value they deliver as judged by the clients 115 to whom the value is delivered.

At step 1304, the voting manager 121 can detect transfer of equity to the client. For example, taxing equity transfers may be based on demand for the equity. Taxing equity transfers may leverage demand by ensuring that what clients 115 work on is perceived as delivering value to the clients 115 who pay for that work. In some embodiments, the taxation may create a market in which there is only demand-side pricing and no supply-side pricing. For example, in the digital world (e.g., digital assets), the marginal cost of goods may approach zero. In another example, in the labor market, the number of hours each client has to work may be assumed to be generally equal and constant. In the aforementioned examples, supply-side pricing may be an attack vector for manipulation. For example, clients 115 might end up directing equity (e.g., work) towards things that aren't useful even if compensated work is a form of public service. A problem may arise when clients are incentivized by equity (e.g., directed to work by dollars) rather than by what the realm of clients (e.g., public) wants and needs. In some embodiments, by eliminating supply-side pricing, efforts may be better aligned between how clients 115 spend their equity and with what's useful to other clients 115.

At step 1306, the voting manager 121 can determine a subset of the transferred equity to be redistributed. The voting manager 121 can determine the subset based on the tax rate. For example, if the tax rate is 50% and the client 115 receives 100 units, then the voting manager would determine to transfer 50 units.

At step 1308, the voting manager 121 can transfer the subset of the equity from the first client to the second client. example, if a first client 115 receives 100 units of equity, the voting manager 121 would transfer 50 units the second client 115.

### Tryouts

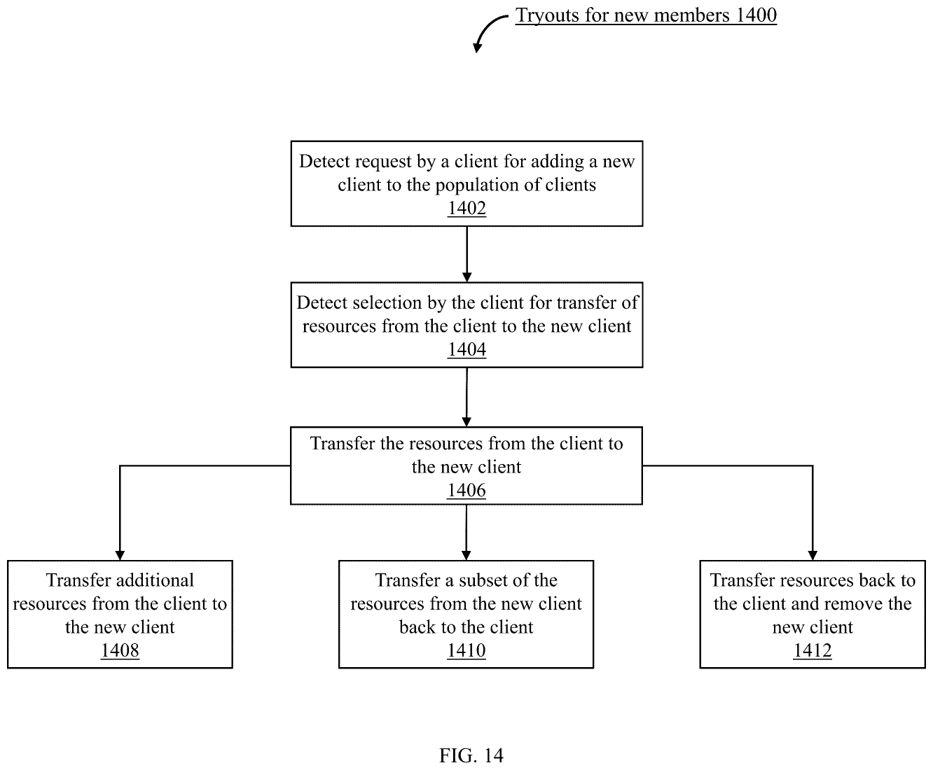

FIG. 14 illustrates a method 1400 of managing new clients. The method 1400 may be performed by the voting manager 121. At step 1402, the voting manager 121 can detect a request by a client to add a new client to the population of clients. The clients 115 can use tryouts to add new clients 115 to the realm.

If any client could induct or add additional clients at no cost, the realm could experience a coup. For example, the coup could be in the form of a Sybil attack. In another example, a client could induct an army of cronies that overrun the existing clients' voting power. Using polls to induct new clients requires an upfront power outlay but a client could still setup a poll to induct a new client with a deadline that is unreasonably short and do so repeatedly or recursively until the realm is overrun. It could be difficult to unwind such an event to restore the realm membership to its form before the coup. Stop gap measures such as rate limiting, imposing deadline minimums, or creating hiring committees could come with their own disadvantages that could either make decision making less nimble or create administrative power that is distinct from power that can be used to hijack a realm. Polls can enable simple collective decisions, while negative equity can be a suitable mechanism for identifying the decision makers. Splitting political power and realm membership can help alleviate the challenges of inducting new clients. While realm power inflates with each new client, there can be a consistent amount (e.g., 100%) of a realm's equity that can be used to modulate realm membership.

At step 1404, the voting manager 121 can detect selection by the client for transfer of resources from the client to the new entity. Any client (or set of clients) can request to use an arbitrary percentage of their equity and use it as a tryout to induct a new client. For example, a client can request the voting manager 121 to tryout a transfer a tenth of their equity to a new client being added to the realm.

At step 1406, the voting manager 121 can transfer the resources from the existing client 115 to the new client 115. The existing client 115 may continue to be taxed on their entire amount of equity (e.g., including whatever amount is transferred as tryout equity). The existing client 115 may cede tax distribution decision making and the corresponding stake to the new client 115. The tryout equity can create a transient hierarchy where the existing client 115 has hiring power and thus some economic and therefore at least some political authority over newly inducted clients 115. However, the limits inherent to equity creates economic limits and pressure such that transferring equity at a certain point is greater than what the existing client 115 can afford. For example, transfers of equity can erase hierarchical links between clients 115.

In some embodiments, equity transfers and tryout equity can be different from just using taxes or polls. For example, taxes apply to the transfer while tryout equity fairly distributes the costs and benefits of inducting a new client 115 to the existing client 115 adding the new client 115. Tryout equity can mitigate against an existing client 115 attempting to overwhelm other clients 115 by inducting many new clients 115. For example, without tryout equity, an existing client 115 could add new clients 115 to stage a coup by poll numbers against other clients 115. However, the tryout equity limits the new power of the new clients 115 to prevent coups.

Clients 115 in the realm can carry costs in the form of whatever stake they are assigned and the political risk in that they wield power. Conversely, these costs can also be benefits as clients 115 in the realm can contribute to the total share of realm resources or lighten the load to help make better decisions. For example, weighing the costs and benefits can be contentious in companies that hire, or in countries that take in immigrants at least in part because the costs and benefits often go to different sets of people. In another example, the benefits go to one set and the costs go to another. In another example, managers in organizations may destructively hire rampantly to inflate their own fiefdoms while the rest of the company foots the bill. In countries, people who do not benefit from immigration can cut off companies' supply of high skill labor, which potentially holds back entire national economies while imposing immeasurable human costs.

Tryouts can address the costs inherent to adding new clients 115 by requiring that those who believe an induction of a new client 115 will be beneficial to pay for it from their own equity. For example, small businesses similarly work and definitionally avoid suffering from administrative bloat, vanity hiring, or other value destroying forms of headcount growth. For example, if a business believes that someone will add more value than it will cost to hire them, then the business will hire them. Otherwise, the business should not hire them. Embodiments of value are not limited an increase in resource production. Value could be decided by the clients 115 in the realm, so value could be defined to be environmental or workplace culture. It could be that an added client 115 will simply reduce the workload and that is a tradeoff someone might understandably want to make. However, it is not a tradeoff that someone who will not benefit from the decreased workload will be forced to pay for. Tryouts of equity can allow clients 115 to enforce this balance between costs and benefits.

Unlike typical equity transfers that cannot be changed after the transfer, tryout equity can be increased, decreased, or canceled altogether. At step 1408, the voting manager 121 can transfer additional resources from the client 115 to the new client 115. For example, the client 115 can transfer more of their equity to increase the tryout equity assigned to the new client 115. At step 1410, the voting manager 121 can transfer a subset of the resources from the new client 115 back to the client 115. For example, the client 115 can decrease the tryout equity assigned to the new equity to transfer back some equity. At step 1412, the voting manager 121 can transfer resources back the client 115 and remove the new client 115 from the realm. For example, the client 115 can cancel the tryout equity altogether and receive all the equity back from the new client 115.

### Negative Allocations

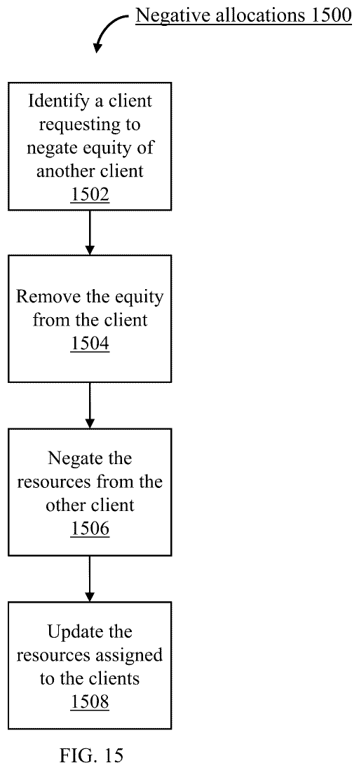

FIG. 15 illustrates a method 1500 of negating equity. The method 1500 may be performed by the voting manager 121. At step 1502, the voting manager 121 can identify a client 115 requesting to negate equity of another client 115. Any client 115 can allocate any portion of their equity against another client 115. In some embodiments, clients can request the voting manager 121 to apply negative equity against the equity of other clients 115. Clients 115 can apply negative equity to expel or censure a client 115 that they believe is harmful to the realm. Negative equity can be a useful mechanism for clients 115 to affect clients 115 to which they have neither allocated taxes nor tryout equity and therefor do not have the ability to return (e.g., rescind) equity. Clients 115 can use negative equity to redistribute equity (e.g., wealth) from a client 115 who is believed to be holding too much (e.g., an unjust amount) of the equity in the realm. For example, negative equity can help avoid that inflated political power cannot be used to overrun the view of the majority of equity holding clients 115. In another example, negative equity prevents clients 115 for hoarding equity because past a certain point, tryouts go upside down on tax obligations and distributing at least 50% of the equity to other clients 115 becomes an inevitability.

At step 1504, the voting manager 121 can remove the equity from the client 115 that made the request to negate the equity of another client's 115. The client 115 that applies the negative equity can be prevented from using that equity for tryouts or equity transfers.

At step 1506, the voting manager 121 can remove the resources from the other client 115. The negated equity can be redistributed from the client 115 to which the negative equity is applied to other clients 115 in the realm. For example, the confiscated portion can be redistributed pro rata. The negative equity can reduce the other client's 115 equity. In some embodiments, negative equity do not alter the components of stake, but they can deduct from the final sum that makes up a client's 115 stake. For example, the negative equity can be a 1:1 reduction so applying 5 units of negative equity to another client 115 will reduce that client's equity by 5 units.

At step 1508, the voting manager 121 can update the stake held by the client 115. In some embodiments, when the negative equity applied to a client 115 exceeds their remaining equity, the client 115 can be expelled from the realm. For example, since negative equity decreases the client's 115 stake, too much negative equity can cause a client's 115 stake to decrease below an expulsion threshold (e.g., 0). When the client's 115 stake decreases below a threshold, the client 115 can be expelled by the voting manager 121 from the realm and whatever equity they had can be redistributed pro rata to everyone in the realm.

### Example Computer Implementations

Techniques operating according to the principles described herein may be implemented in any suitable manner. Included in the discussion above are a series of flow charts showing the steps and acts of various processes for polling-based resource management among distributed clients. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein. Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (i.e., as a single unit or separate units), or some of these functional facilities may not be implemented.

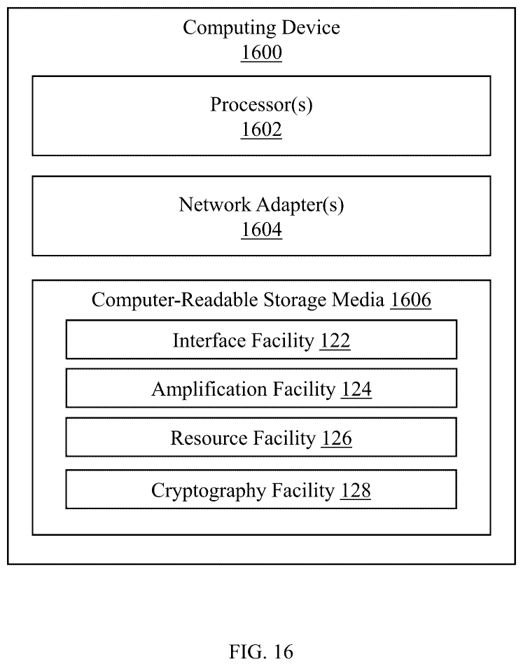

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 1606 of FIG. 16 described below (i.e., as a portion of a computing device 1600) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1A, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 16 illustrates one exemplary implementation of a computing device in the form of a computing device 1600 that may be used in a system implementing techniques described herein, although others are possible. It should be appreciated that FIG. 16 is intended neither to be a depiction of necessary components for a computing device to execute the facilities in accordance with the principles described herein, nor a comprehensive depiction.

Computing device 1600 may comprise at least one processor 1602, a network adapter 1604, and computer-readable storage media 1606. Computing device 1600 may be, for example, a desktop or laptop personal computer, a personal digital assistant (PDA), a smart mobile phone, a server, a wireless access point or other networking element, or any other suitable computing device. Network adapter 1604 may be any suitable hardware and/or software to enable the computing device 1600 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1606 may be adapted to store data to be processed and/or instructions to be executed by processor 1602. Processor 1602 enables processing of data and execution of instructions. The data and instructions may be stored on the computer-readable storage media 1606.

The data and instructions stored on computer-readable storage media 1606 may comprise computer-executable instructions implementing techniques which operate according to the principles described herein. In the example of FIG. 16, computer-readable storage media 1606 stores computer-executable instructions implementing various facilities and storing various information as described above. Computer-readable storage media 1606 may store the interface facility 122, the amplification facility 124, the resource facility 126, and the cryptography facility 128.

While not illustrated in FIG. 16, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A method of conducting a poll among a plurality of clients, the method comprising:
in response to a first client of the plurality of clients submitting a vote in the poll, confirming, by at least one processor, whether an amplification that the first client has applied to the vote is less than an amplification available to the first client for the poll; and
recording, by the at least one processor, the vote of the first client in a distributed data store for the poll, wherein recording the vote comprises recording in a data structure of the distributed data store an identifier for the vote of the first client, an identifier for a preceding vote in the poll, the amplification applied to the vote by the first client, and a vote choice of the first client in the poll.

2. The method of claim 1, further comprising:
decreasing, by the at least one processor, the amplification available to the first client for the poll based on the amplification applied to the vote by the first client.

3. The method of claim 1, further comprising:
modifying, by the at least one processor, based on the amplification applied to the vote by the first client, a respective amplification available to other clients, of the plurality of clients, for future polls.

4. The method of claim 1, further comprising:
identifying, by the at least one processor, that one or more of the plurality of clients submitted one or more tags associated with the poll;
identifying, by the at least one processor, that one or more of the plurality of clients submitted one or more interactions with the one or more tags associated with the poll; and
generating, by the at least one processor, an order of display of the one or more tags based on the one or more interactions.

5. The method of claim 1, wherein the first client submitting the vote comprises:
detecting, by the at least one processor, that the first client has submitted a first vote for a first option of the poll and a second vote for a second option of the poll;
confirming, by the at least one processor, whether a first amplification the first client has applied to the first vote and a second amplification the first client has applied to the second vote are collectively less than the amplification available to the first client for the poll; and
recording, by the at least one processor, the first vote and the second vote of the first client in a the distributed data store for the poll, wherein recording the vote comprises recording in the data structure of the distributed data store a first identifier for the first vote and a second identifier for the second vote of the first client, the identifier for the preceding vote in the poll, and the first amplification and the second amplification applied to the first vote and the second vote by the first client.

6. The method of claim 1, wherein the vote of the first client is recorded responsive to confirming, by at least one processor, that a time at which the first client has applied to the vote satisfies a time condition until when the vote can be recorded for the poll.

7. The method of claim 1, further comprising:
detecting, by the at least one processor, a plurality of deadline votes submitted by the plurality of clients on at least one time-condition until the vote for the poll can be recorded; and
recording, by the at least one processor, a time condition of the at least one time-condition based on the plurality of deadline votes indicating the time-condition.

8. The method of claim 1, further comprising:
receiving, by the at least one processor, from the first client of the plurality of clients submitting a vote in the poll, a resource selection of resources to assign to at least one other client of the plurality of clients;
selecting, by the at least one processor, based on the resource selection, a subset of the resources to transfer to the at least one other client of the plurality of clients; and
transferring, by the at least one processor, the subset of the resources to the at least one other client.

9. The method of claim 1, further comprising:
detecting, by the at least one processor, a request submitted by the first client to transfer resources from the first client to at least one new client; and
transferring, by the at least one processor, responsive to confirming that the resources in the first request is less than a maximum resource available to the first client, the resources from the first client to the at least one new client.

10. The method of claim 1, further comprising:
detecting, by the at least one processor, a request submitted by the first client to remove shares of resources from the first client to remove the resources from a second client of the plurality of clients; and
transferring, by the at least one processor, the shares of the resources from the first client and the second client to the plurality of clients.

11. A method of electronically conducting a poll among a plurality of clients, the method comprising:
identifying, by at least one processor, a cryptographically-sealed sequence of votes for the poll, the cryptographically-sealed sequence of votes being stored in a distributed data store for the poll;
in accordance with an order of votes indicated by the cryptographically-sealed sequence of votes, obtaining, by the at least one processor, for each vote in the poll, a choice of the vote by a client of the plurality of clients and an amplification applied to the vote by the client submitting the vote; and
updating, by the at least one processor, shares of resources assigned to each client of the plurality of clients, based on choices of votes and the amplification applied to each vote in the poll.

12. The method of claim 11, wherein each vote in the poll is associated with the shares of equity, and wherein allocating the shares of allocations comprises:
distributing, by the at least one processor, the allocations among the plurality of clients; and
transferring, by the at least one processor, among the plurality of clients, the shares of the resources based on the amplification applied to the votes in the poll.

13. The method of claim 12, wherein the shares of the allocations among the plurality of clients are distributed based a number of clients of the plurality of clients.

14. The method of claim 11, further comprising:
transferring, by the at least one processor, from a first client of the plurality of clients to which the shares of resources were allocated, a subset of the shares of resources to at least one different client of the plurality of clients.

15. The method of claim 14, further comprising:
detecting, by the at least one processor, from the first client of the plurality of clients, a client selection of the at least one different client of the plurality of clients to which the subset of the shares of resources should be transferred.

16. The method of claim 11, wherein allocating comprises:
identifying, by the at least one processor, a winning client of the plurality of clients that received the greatest amplification based on the amplification applied to each vote in the poll; and
assigning, by the at least one processor, the shares of resources to the winning client.

17. The method of claim 11, wherein allocating comprises:
identifying, by the at least one processor, a subset of clients of the plurality of clients selected in each vote in the poll;
identifying, by the at least one processor, for each of the subset of clients, a proportion of the amplification associated with the client; and
assigning, by the at least one processor, the shares of resources to each of the subset of clients based on the proportion amplification.

18. The method of claim 11, wherein the cryptographically sealed sequence of votes is a hash chain.

19. A method of electronically conducting a poll among a plurality of clients, the method comprising:
identifying, by at least one processor, a cryptographically-sealed sequence of votes for the poll, the cryptographically-sealed sequence of votes being stored in a distributed data store for the poll;
in accordance with an order of votes indicated by the cryptographically-sealed sequence of votes, obtaining, by the at least one processor, for each vote in the poll, a choice of the vote by a client of the plurality of clients and an amplification applied to the vote by the client submitting the vote; and
determining, by the at least one processor, an outcome of the poll based on choices of votes and the amplification applied to each vote in the poll.

20. The method of claim 19, wherein determining the outcome comprises:
determining, by the at least one processor, the outcome of the poll by identifying a winning client of the plurality of clients that received the greatest amplification based on the amplification applied to each vote in the poll; and
assigning, by the at least one processor, shares of resources to the winning client.

21. The method of claim 19, wherein determining the outcome comprises:
determining, by the at least one processor, the outcome of the poll by:
identifying a subset of clients of the plurality of clients selected in each vote in the poll;
identifying for each of the subset of clients, a proportion of the amplification associated with the client; and
assigning the amounts of shares to each of the subset of clients based on the proportion of the amplification.

22. The method of claim 19, wherein obtaining the choice of the vote comprises:
identifying, by the at least one processor, for each vote in the poll, a public key for decrypting the respective choice of the vote by the client of the plurality of clients and the amplification applied to the vote by the client submitting the vote; and
obtaining, by the at least one processor, for each vote in the poll, a choice of the vote by a client of the plurality of clients and the amplification applied to the vote by the client submitting the vote.

23. The method of claim 19, further comprising:
identifying, by the at least one processor, in the cryptographically sealed sequence of votes provided by the client, a hash chain comprising a respective hash for each vote in the poll, wherein the respective hash is associated with a respective choice of the vote by a respective client of the plurality of clients and a respective amplification applied to the vote by the respective client submitting the vote;
generating, by the at least one processor, a comparison between the hash chain of the cryptographically sealed sequence of votes of the client and a different hash chain of a different cryptographically sealed sequence of votes provided by a different client; and
determining, by the at least one processor, based on the comparison, whether to verify the cryptographically sealed sequence of votes.
